(19) United States
(12) Patent Application Publication
(10) Pub. No.: US 2014/0187375 A1
(43) Pub. Date: Jul. 3, 2014

(54) Energy Generation Method and Apparatus by the Harnessing of Centrifugal Force

(71) Applicant: Geoffrey William Good Leviny, New South Wales (AU)

(72) Inventor: Geoffrey William Good Leviny, New South Wales (AU)

(21) Appl. No.: 13/940,230

(22) Filed: Jul. 11, 2013

Related U.S. Application Data
(63) Continuation-in-part of application No. 12/442,832, filed on Mar. 25, 2009, now abandoned.

(30) Foreign Application Priority Data
Sep. 29, 2006 (AU) 2006905381

(51) Int. Cl. F16H 37/04

(52) U.S. Cl. CPC F16H 37/04
USPC 475/182

(57) ABSTRACT

An energy generation apparatus uses centrifugal force to generate energy in a controlled manner. The apparatus includes a dual function input shaft and output shaft rotatably attached to opposite sides of a housing defining an axis of orbit, an output gear fixed upon the output shaft, an input sprocket rotatably mounted on the output shaft, and at least two frame gear assemblies, each having a frame gear and at least two weight gears. The frame gears rotate about their centres and also orbit around the output gear in response to an input from the input sprocket.

### CROSS REFERENCE TO RELATED APPLICATIONS

This application is a continuation-in-part application of U.S. patent application Ser. No. 12/442,832 filed on Mar. 25, 2009 now pending and incorporated by reference herein.

### TECHNICAL FIELD

This invention generally relates to an energy generation method and apparatus and in particular to a self-powering energy generation method and apparatus which controls the use of centrifugal force for the generation of energy in a controlled manner.

In a particular but not exclusive aspect, the present invention relates to a method and apparatus for transferring centrifugal force into a cranking force to apply energy to a shaft when the center of gravity/mass within a gear or other rotational body is manipulated to rotate continuously off center to one side around the center of another gear.

In a further but not exclusive aspect, the present invention relates to an energy generation method and in particular to a power regulator for recycling some of the energy harnessed so as to provide a self-powering or a continuous supply of power for external applications.

### BACKGROUND ART

Centrifugal force represents the effects of inertia that arise in connection with rotation and which are experienced as an outward force away from the centre of rotation. A number of attempts have been made to harness and utilize centrifugal force as a useful energy source. Examples of apparatus using this principle are disclosed in JP57137741A2, JP08256470A2, US20040234396A1, JP10153163A2 and JP10026074A2. As far as the applicant is aware none of the apparatus disclosed in the above documents have been successfully implemented.

For example US20040234396 describes a mode for generating electricity. Following a connection of a controllable electric driving motor and it's switching on of a disc rotor which generates a centrifugal force at the rim of the rotor circumference. The application of this force causing centrifugal acceleration of a liquid and subsequently achieves a rise in liquid pressure, which are quadratic in respect to circumferential velocity measured at the other rim of the disc rotor. The centrifugal force and energy potential are used for driving a hydraulic motor, in order to rotate a driving shaft; and transfer rotating motion to a generator that serves for generating electricity. As far as the applicant is aware this apparatus has not been successfully implemented to produce electricity.

Various components used in producing the present invention are well known, for example items such as gears and chains, as well as, some component systems.

Clearly it would be advantageous of the present invention to provide a contrivance which overcomes or at least ameliorates some of the disadvantages set forth above.

### SUMMARY OF THE INVENTION

The apparatus and method of energy generation is based on the transfer of centrifugal force into a cranking force to apply energy to a gear. The present invention is implemented by maintaining an added off center weight of a gear to one side of that gear whilst in orbit regardless of any spin it may undergo, such that the offset mass of the gear orbits in a manner synchronous to the center of orbit while the actual gear may be freely spinning in orbit.

Energy is delivered in two ways;
1. A first force is a mechanical transfer of an input power from an input gear to an output gear through a mechanical sequence of chains and gears. The transfer is not a completely interconnected sequence. It has one coupling which is held by and dependent on, centrifugal force acting on offset weights, which by being revolved synchronously are pulled outwards on the radial line. When the conveyance of the input force is increased by a load on the output or friction the weights are pulled increasingly away from the radiating centrifugal line.
2. This weight movement away from the radial line causes the gears on which they are mounted by bearings to be pulled by centrifugal force and so spin and transmit this added power via idler gears (to reverse the direction) to the central output gear. This is the second force.

Since the first force is a direct product of the input force and the second force is a consequential force resultant from the advance of the weights, all the output of the of the second force less frictional loss, is gain, and so can be used to power external applications. Since both forces are governed by the input meeting resistance against rotation of the weight gears by centrifugal force, both the first and second forces apply an equal output force regardless of their revolution rates. Thus input power is amplified to double at the output gear.

In accordance with a first aspect, the present invention provides an energy generation apparatus comprising: a dual function input shaft and output shaft rotatably attached to opposite sides of a housing defining an axis of orbit; an output gear fixed for rotation with said output shaft; an input sprocket rotatably mounted on said output shaft; at least two frame gear assemblies, each said frame gear assembly comprising a frame gear, a shaft, a drive gear, a weight gear and an idler gear, wherein said at least two frame gear assemblies having an axis of rotation, said frame gear assemblies being mounted for orbital movement around said output gear in response to an input from said input sprocket, and means to convey said orbital movement to the output gear; means for positioning and maintaining the effective center of mass of said frame gear at a position or positions synchronously off-center relative to the center of said frame gears to cause rotation of said frame gear about their axis of rotation in response to a centrifugal force caused as a consequence of the orbital movement of said frame gear assemblies; means of coupling said frame gears to said output gear via said idler gear and reversing the direction whereby motion of said frame gear is transmitted to said output shaft equal to said input of the frame gear assemblies around said output gear; and said spin of the output gear is conveyed via the output shaft to return some of output energy to drive the input by direct or variable mechanical drive, or by any other means such as hydraulic or electric drive systems, so as to maintain the system.

Preferably, the apparatus may include at least one pair of frame gear assemblies, respective frame gear assemblies of said pair being arranged symmetrically on opposite radial sides of the output gear. Each said frame gear assembly may comprise a frame gear and mass adjusting means carried by said frame gear for adjusting the center of mass of the frame gear assembly.

Preferably, the apparatus may include a frame gear shaft for each frame gear assembly and mounted at a position spaced radially from and extending parallel to the output shaft, said frame gear assembly being supported to the frame gear shaft for free rotation there around. The mass adjusting means may comprise weight gears, said weight gears being movably mounted on the frame gear to enable adjustment of the effective center of mass of the frame gear assembly. The weight gears may comprise a pair or more of weight gears arranged symmetrically on opposite radial sides of the axis of rotation of the frame gear. Each weight gear may be supported on the frame gear for rotation about an axis extending parallel to the axis of the rotation of the frame gear. The center of mass of each weight gear may be offset relative to its axis of rotation and maintains that offset synchronously such that offset is maintained even when the frame gear rotates about its own axis. The weight gears may be arranged such that when each weight or center of mass of each weight gear is concurrently radially outer most and wherein the weight gears on frame gears on the opposite sides of the output shaft are arranged symmetrically relative to each other. The weight gears may be in mesh with a common drive gear coaxial with the frame gear through which rotation by a drive chain can be transmitted to the weight gears from the input sprocket, said drive gear being mounted to frame gear shaft for rotation therewith.

Preferably, the frame gear shafts may be supported by spaced radial arms mounted for rotation relative to the output shaft, the radial arms extending symmetrically on opposite radial sides of the output shaft. Each said frame gear assemblies may be coupled to the output gear through idler gears. The frame gear shafts may be adapted to receive an input from said input sprocket to rotatably drive the drive gears against the weight gears with said weights which are synchronously held outwards by centrifugal force.

Preferably, the orbital motion may be applied to said frame gear assemblies as torque. The torque may be resisted as spin by the coupling to the output gear causing the drive chains to act as a solid. The solid behaviour of the chains may be applied to the frame gear assembly as rotational torque about the output shaft for complete conveyance of all input less friction through the meshing of the drive gear to the weight gears to the frame gears to the idler gears to the output gear to form a first force applied to the output gear.

Preferably, the frame gear assembly may be rotating about the output shaft all parts of the frame gear will express centrifugal force as a by-product which increases as the radial arms rotate faster. Any increase in revolution rate of the radial arms may increase both rotational force and centrifugal force applied to the weights by a factor of four proportionally in accordance with E=½MV² and F=MV²/R and will increase the power range that can be amplified.

Preferably, the rotation transmitted to the weight gears may cause the weights thereon mounted to move away from the most outward line causing said mass adjusting in response to any differential between the input and output power caused by friction or output load. The average movement of the weights may be so caused, and being subjected to said centrifugal force, will apply the same torque as that force that caused it in the conveyance of the first force. The torque may be applied to the frame gear in response to the centrifugal force applying to it in a radial line from the output shaft. The torque (less friction) may be applied through the idler gears in a reversed direction to the output gear to form a second force applied to the output gear.

Preferably, with both the first force and the second force governed by the input meeting resistance against rotation of the weight gears which are held by centrifugal force being a by-product of angular momentum, both the first and second forces may apply equal output force regardless of their revolution rates.

Preferably, all gearing may be configured to suit the method of maintaining the input power when diverting any of the output to the input.

Preferably, the gearing may be a one to one gearing if all power is to be returned at a one to one revolution rate which requires the rotation of either the frame gears or the radial arms singularly, or any combined rotation of the frame gears or the radial arms to match the input rotation rate that these gears cause at the output, and with both applying the same torque the output will equal twice the input power less friction.

Preferably, the first force may be applied with any sprocket sizing when it alone is rotating requiring only the gearing of the second force to be configured one to one such that a combined one to one gearing is maintained when the frame gears rotate about their own axis.

Preferably, when calculating the one to one gearing of the second force it may be factored in that throughout each rotation of the radial arms, the weight gears maintain their orientation, and in doing so revolve around the drive gear, such that the drive gears must turn the number of teeth as there are on the weight gears in addition to the one full turn of the drive gear required to match the rotation of one frame gear rotation.

Preferably, to achieve a one to one gearing each respective gear may contain the following number of teeth: (a) weight gears with 46 teeth; (b) final drive gear with 30 teeth; (c) frame gear with 120 teeth; (d) output gear with 120 teeth; (e) final drive sprocket with 15 teeth; and (f) multiple chain sprocket with 38 teeth.

Preferably, the first force may be a direct product of the input force and may be fully conveyed to the output, and the second force may be a consequential force resultant from centrifugal force acting on the advance of the weights, all the output of the of the second force less frictional loss, may be gain, and so can be used to power an external application.

Preferably, power may be increased by incorporating multiple frame gears, weight gears or the use of modified weight arms whereby the weight gears can be mounted on shafts extending through the frame gears and mounted on bearings such that the non-gear drive side has a weight arm attached, such that with the weights balanced on either side, a more even load would be applied to the frame gears while increasing the mass of the weights and so the power range that can be amplified.

Preferably, multiple force or energy amplifying apparatuses may be powered in series for multiple amplification of power for returning power for self-powering.

In accordance with another aspect, the present invention provides a force or energy amplifying apparatus comprising: at least one gear assembly having an axis of rotation, said gear assembly being mounted for orbital movement around an orbit axis, means for causing said gear assembly to orbit around said orbit axis in response to a rotational input; means for causing rotation of said frame gear assembly about its axis of rotation during said orbital movement of said frame gear assembly as a consequence of centrifugal force; and means for extracting energy from said orbiting and rotating gear assembly.

Preferably, part of the energy extracted from the orbiting and rotating gear assembly is returned to provide the rotational input.

In another aspect, the present invention provides a force or energy amplifying apparatus comprising: an input shaft; an output shaft defining an orbit axis; an output gear fixed for rotation with said output shaft; at least one frame gear assembly having an axis of rotation, said frame gear assembly being mounted for orbital movement around said output gear in response to an input from said input shaft; means for positioning and maintaining the effective center of mass of said frame gear assembly at a position or positions off-center relative to the center of said frame gear whereby to cause rotation of said frame gear assembly about its axis of rotation during said orbital movement of said frame gear assembly; and means coupling said frame gear to said output gear whereby motion of said frame gear can be transmitted to said output shaft.

Suitably means are provided for returning part of the output from the output shaft to drive the input shaft to maintain operation of the apparatus. The returning means may comprise mechanical or hydraulic transmission means.

Preferably, the apparatus comprises at least one pair of frame gears assemblies, respective frame gear assemblies of said the being arranged symmetrically on opposite radial sides of the output gear.

Suitably a frame gear shaft for each frame gear assemblies is mounted at a position spaced radially from and extending parallel to the output shaft so that the frame gear assemblies orbit at a constant radius from the orbit axis. The frame gear assemblies are suitably supported to the frame gear shaft for free rotation there around.

Each frame gear assembly suitably comprises a frame gear and mass adjusting means carried by the frame gear for adjusting the center of mass of the frame gear assembly.

In one form the mass adjusting means comprise weight gears, said weight gears being movably mounted on the frame gear to enable adjustment of the effective center of mass of the frame gear assembly.

Preferably, the weight gears comprise a pair of weight gears arranged symmetrically on opposite radial sides of the axis of rotation of the frame gear. Each weight gear is suitably supported on the frame gear for rotation about an axis extending parallel to the axis of the rotation of the frame gear. The weight gears may be supported for rotation on pedestal shafts mounted on one side of the frame gear. Preferably the center of mass of each weight gear is offset relative to its axis of rotation. Each weight gear suitably carries a weight offset from its axis of rotation. Preferably the weight gears are in mesh with a common drive gear coaxial with the frame gear through which rotation can be transmitted to the weight gears. The weight gears are arranged such that each weight or center of mass of each weight gear is concurrently radially outermost. Suitably the weight gears on opposite sides of the output shaft are arranged symmetrically relative to each other.

Preferably, a drive gear is mounted to the frame gear shaft for rotation therewith. Preferably the frame gear shafts are supported by spaced radial arms mounted for rotation relative to the output shaft, the radial arms extending symmetrically on opposite radial sides of the output shaft. Preferably the frame gear shafts are adapted to receive an input from an external source to drive the drive gears, the input force of the input being amplified in use by the apparatus of the invention.

Preferably, the frame gears are coupled to the output gear through idler gears. The idler gears are suitably rotatable mounted on the radial arms.

The rotation of the center of gravity or mass around the center of a gear as achieved by the pair of weigh gears mounted to a frame gear could be achieved by any means such as rotating weights as employed and described above or variations including any means of weight transfer such as sliding weights whether operated by a cam or solenoid or hydraulics.

In another form, hydraulic fluid may be used to adjust the center of gravity or mass of the frame gear assemblies.

Whilst the invention is most suitably used in relation to rotatable and orbiting gears, it may also be applied to other rotatable bodies.

Thus the present invention in another aspect provides a self-powered force or energy generating apparatus, said apparatus comprising at least one body rotatable about an axis of rotation, said body being mounted for orbital movement around an orbit axis, means for causing said body to orbit around said orbit axis in response to a rotational input, means for causing rotation of said body about its axis of rotation during said orbital movement of said body as a consequence of centrifugal force, means for obtaining a force or energy output from said orbiting and rotating body and means for returning part of said output to said input to maintain operation of said apparatus.

In yet a further aspect, the present invention provides in a broad aspect, a method of amplifying force or energy applied from an input, said method including the steps of causing a rotational body having an axis of rotation to orbit at a constant radius about an orbit axis in response to said input force or energy, weighting said body such that when orbiting, said body rotates under the influence of centrifugal force about its axis of rotation, and extracting energy from said orbiting and rotating body.

Preferably, the method further comprises the step of applying part of the extracted energy to the input to maintain the orbiting and rotational movement of the rotational body. The body suitably is weighted variably to maintain its rotation during the orbital movement thereof.

Given that the properties of mass exhibited by a body spinning around a fixed point expresses angular momentum and centrifugal force, the function of the apparatus is to spin or rotate a body so as to maintain the angular momentum and convert centrifugal force into a cranking force to generate energy. All these features are known to science and as with solar energy are unlimited.

An input power source is required to start up the system. When running, some energy is required to be returned to the input to maintain the operation upstream of the output, and to compensate for frictional losses.

The method of amplifying force or energy applied from an input is achieved as described in the following paragraphs:

If the input drive, acting through the final chain drive were applied to a solid rigid frame gear mass, the chain would act as a solid, and transfer the energy of the input, to the rotational effort of the frame gear mass around the output gear, and deliver it as usable energy at the output gear, equal (less friction) to the input.

In the apparatus according to the invention, the frame gear is not a solid rigid mass, but it will behave as such due to the centrifugal hold on the weights making it act as a solid. Since this centrifugal hold is not absolute, in resistance to the input against the weight gears, the weight will rotate away from the line of centrifugal force, and having done this, the effective center of gravity (mass) of the frame gear is then to the side of the frame gear. With centrifugal force now acting to that side of the frame gear, the frame gear will rotate, which it then delivers to the output gear as a second force. Calculations of this second force show that it is the same as the input. Thus output equals twice the input.

Since output forces are the result of the rotation of the weight gears, (provided gearing is one to one) both forces are delivered simultaneously, and regardless of mix of contribution, output rpm will be the same as input rpm, all be it at twice the energy.

While the system is in operation with a given input force, any resistance or take off at the output, will cause the same sequences offerees as would additional input, because in both cases, the input force will be expressed as greater resistance at the first point of contact with the frame gear, this being the weight gear. The effect will be to rotate the weights further away from the line of centrifugal force.

This will increase both output forces, while using only the input force of one, to increase the rotational effort of the frame gear mass around the output gear, and so add rotation to the output gear and increase leverage to rotate the frame gear, and so add rotation to the output gear.

The apparatus of the present invention has a number of applications including as stand-alone power plants as single units or multiple units in any configuration including stacked on top of one another, side by side including on common axle shafts, for any mechanical energy application including water pumping and treatment, the generation of electricity, powering of vehicles, marine vessels, air craft, or any other mechanical device including use in space or anywhere. The machine of the invention may be made to any size to suit any requirement for on-site and portable, to regional supply of energy. Regional power generation would eliminate the need and costs associated with long distance transportation of energy be it electricity, fossil fuel or whatever.

In accordance with a still further aspect, the present invention provides an apparatus for harnessing centrifugal force into a cranking force to apply energy to a shaft when the centre of gravity/mass within a gear is manipulated to rotate continuously off centre to one side of that gear around the centre of another gear, the apparatus comprising: a dual function input shaft and output shaft rotatably attached to opposite sides of a housing defining an axis of orbit; an output gear fixed for rotation with said output shaft; an input sprocket rotatably mounted on said output shaft; at least two frame gear assemblies, each said frame gear assembly comprising a frame gear and an idler gear, wherein said at least two frame gear assemblies having an axis of rotation, said frame gear assemblies being mounted for orbital movement around said output gear in response to an input from said input sprocket, and means to convey said orbital movement to the output gear; means for positioning and maintaining the effective center of mass of said frame gear assemblies at a position or positions synchronously off-center relative to the center of said frame gears to cause rotation of said frame gear assemblies about their axis of rotation in response to a centrifugal force caused as a consequence of the orbital movement of said frame gear assemblies; and means of coupling said frame gears to said output gear via said idler gear whereby motion of said frame gear is transmitted to said output shaft equal to said input of the frame gear assemblies around said output gear.

Preferably, energy at the output shaft may be transmitted to the input sprocket to recycle energy so as to provide power for self-powering the apparatus and providing a continuous supply of power for external applications. The recycled energy may be produced by connecting the output shaft to the input sprocket in a manner that provides a controlled differential coupling so as to control the amount of offset of the gravity/mass within the rotating gear, by varying the advance of the weights and so varying the energy generated. The controlled differential coupling may comprise a hydraulically controlled coupling. The coupling may comprise a pair of pistons mounted to the output shaft of the apparatus, the pistons being a fixed rotation with the output shaft but being movable longitudinally in opposite directions relative to the output shaft. The hydraulic fluid pressure may be provided between the pistons to cause the pistons to move apart. Movement of the pistons apart may vary the rotational coupling between the output shaft and input sprocket.

Preferably, the pistons may carry helical slots and the input sprocket includes pins receivable in the slots, such that movement of the pistons apart will vary through the cooperating pins in their slots to alter the differential coupling between the input sprocket and the output shaft and so alter the amount of synchronous offset of the weights.

Preferably, the self-powering apparatus may be a variable power hydraulically controlled returning apparatus or may be a power regulator for maintaining, increasing, reducing or stopping the power transmitted from the output to the input, said power regulator being incorporated within a multiple chain sprocket.

Preferably, a hydraulic cylinder may be created on an inner side of said multiple chain sprocket to form the housing of the variable power returning apparatus. Preferably, the apparatus may further comprise two pistons located on the inner side of the multiple chain sprocket. Each piston may have at least two slots equally spaced around the insides and outsides of both pistons. The inside slots may be horizontal. The outside slots may be helical. Threaded holes may be located around the multiple chain sprocket to align with the said helical slots and the insertion of screw pins. Each set of screw pins may be positioned so as to locate into the helical slots in the outside of each of said two pistons.

Preferably, the pistons may be tubular such that they are located to neatly fit around the output shaft. Hydraulic seals may be located on the inner facing ends of each said piston and set back to allow a space between the two pistons when they are together, so as to facilitate controlled separation by maintaining a space for hydraulic oil Each set of pistons may be engaged by a set of locating pins which are inserted equally around, or on opposite sides of the output shaft such that half of the locating pins are spaced to engage with each piston. The engaging pins may be fitted into said longitudinal slots on the inside of said pistons, by sliding said pistons outward after the said pins are inserted into the said output shaft. The pistons may then be free to slide horizontally on the output shaft as far as the seals will permit.

Preferably, the output shaft may have an axially extending hole drilled through the middle of the output shaft and extending from one side of multiple chain sprocket to an outlet hole located in line with the mid line of the final drive sprockets. The cylinder of the multiple chain sprocket may be slid over the pistons to accommodate the pistons centrally, when the pistons are together at the point of the oil outlet hole so as to align with the mid line of the final drive sprocket. The helical slots in the outside of the two pistons may be cut at opposite angles to each other and are fitted on the output shaft such that the slots form an arrow head in the direction of rotation of the output shaft. The slots may be cut at any suitable helical angle so as to provide optimal rotation of the weights to near ninety degrees when the pistons are hydraulically separated by an hydraulic pump to their maximum extent.

Preferably, the multiple chain sprocket may be coupled to the final drive sprocket of the apparatus by the drive chains in such a manner that when the pistons are together at the outlet oil hole, each of the weights on the weight gears are set outwards on the radial line or slightly backwards from it. Preferably, on the drilled end of said output shaft may be fitted a rotary oil union with an hydraulic pump connected via a hydraulic hose to the rotary oil union. The hydraulic fluid pressure may be provided between the pistons to cause the pistons to move apart such that movement of the pistons apart will screw the cooperating pins along the slots causing a differential rotational coupling between the input sprocket and the output shaft. The rotational differential coupling may transfer downstream to force and hold the weights off-centre. The weight offset may cause torque and rotation of the frame gear assembly to be applied to the output. The output may be additionally returned to the input or made available to power or drive other applications.

Given the properties of mass exhibited by a body spinning around a fixed point expresses angular momentum and centrifugal force, the function of the unit is to spin a body so as to maintain the angular momentum and convert centrifugal force into a cranking force to generate energy. All these forces are known to science and as with solar energy are unlimited.

The apparatus of the present invention has a number of applications including as stand-alone power plants as single units or multiple units in any configuration including stacked on top of one another, side by side including on common axle shafts, for any mechanical energy application including water pumping and treatment, the generation of electricity, powering of vehicles, marine vessels, air craft, or any other mechanical device including use in space or anywhere. The machine of the invention may be made to any size to suit any requirement for on-site and portable, to regional supply of energy. Regional power generation would eliminate the need and costs associated with long distance transportation of energy be it electricity, fossil fuel or whatever.

### BRIEF DESCRIPTION OF THE DRAWINGS

In order that the invention may be more readily understood and put into practical effect, reference will now be made to the accompanying drawings which illustrate a preferred embodiment of the invention and wherein:

FIG. 1 is plan view of an apparatus according to an embodiment of the invention;

FIG. 2 is a sectional side view of the apparatus along line A-A of FIG. 1;

FIG. 3 is a sectional plan view of the apparatus along line B-B of FIG. 2;

FIG. 4 illustrates a practical embodiment of apparatus according to the invention;

FIGS. 5 to 15 are charted test results carried out on the apparatus of FIG. 4;

FIG. 16 illustrates the detail of a controlled differential coupling used as a power return system in accordance with the present invention; and

FIG. 17 illustrates how synchronous rotation of multiple weights maintains a constant offset despite any spin of gear on which they are mounted. FIG. 18 shows a multiple chain sprocket arrangement.

### DETAILED DESCRIPTION OF THE PREFERRED EMBODIMENT

Some inventions can involve new discoveries. The mechanism causing gravitational force is not understood, but it is undeniable that it exists, so it is accepted. In the case of centrifugal force it is theorized that it is simply an apparent reaction to centripetal force, not a force in its own right. This is not proven. Centrifugal force is simply dismissed because the cause is not known or understood, while an explanation is postulated.

The accepted postulation is that centripetal force is applied at right angles to the rotating body and so applies a constant change in direction to the body without retarding it, and so does not retard angular momentum which is known to be a constant.

There is a flaw in this hypothesis. It is that a change in direction can only result from an external force. In the case of a centripetal inward force/pull applied at right angles it can only be caused by an inward movement, which must require a shortening of the tether, which does not happen.

If one considers a mechanical system where both the central pivot and the tethered body move at the same velocity in the same direction with no shortening of the tether, then there is no centripetal force and therefore no change in direction. If the central pivot point is stopped, the tethered body will start to change direction to a circular orbit and express centripetal force.

What has happened is that the orbiting body is attempting to advance ahead of the central pivot. In doing this it attempts to exceed the length of the tether and in doing this is pulled constantly slightly backwards since the tether is a constant length. This is an external force, and this must retard angular momentum. Since angular momentum is a constant without retardation, there must be an external force being applied in the opposite direction to the centripetal force to offset that centripetal force. Such a force is called centrifugal force however it is caused.

If an orbiting body such as the moon was to be stationary within the principle influence of the earth's gravity, it would be pulled directly toward the earth at an accelerating velocity until it crashed into the earth. In the natural world the moon does not crash into the earth because it is orbiting at a constant velocity that produces centrifugal force at its radius from the earth that balances the earth's gravity.

Note that gravity is a force, it conforms to Newtonian physics since it causes acceleration, accordingly for centrifugal force to balance gravity it must also be a force. While this is not proof of the existence or absence of the nature of centrifugal force, it remains clear that gravity has been resisted, and if this resistance is simply called centripetal force or the reactionary term centrifugal force, there is tension between the earth and moon and it is this that has been harnessed in the present invention.

Regardless, it is undeniable that rotating weights spinning around a central point exert a continuous outward force as can be seen in the operation of a centrifugal clutch, where brake pads are spun, and so forced out against the inner face of a drum with a force that creates friction to lock the inner rotation to the outer drum. There are many other examples of the use of centrifugal force such as speed regulating governors, the pivoted lawn mower blades and the centrifuge.

The present invention uses the same principal as spinning weights with continuous outward force, but instead of applying friction by the outward force for locking, as with the centrifugal clutch, it applies torque to a rotating gear, which is then transmitted to the output via the idler gears.

The novelty of the present invention is that the weights are held synchronously outwards by centrifugal force, while pulled offset from that radial line collectively to one side of the outer gears (frame gears) by the tension of transmitting the input to the output, and so the offset is proportional to that tension. With the weight gears free to turn on their bearing mountings on the frame gear, it is in the specific gearing that the weights are maintained synchronously no matter what component is rotated. The use of centrifugal force was backed up by the precedent of a patent having been approved in 1985 to utilize centrifugal energy.

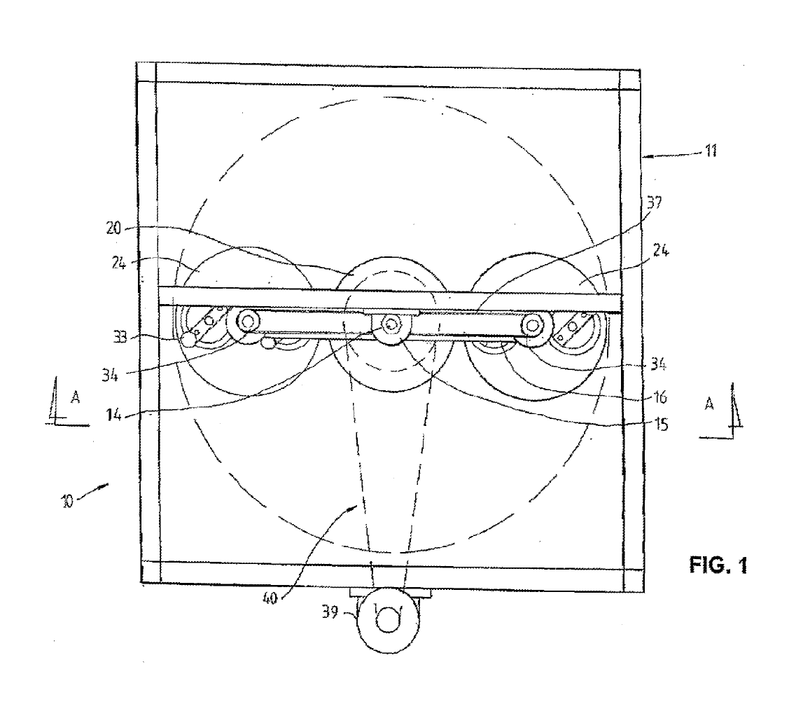

Referring to the drawings and firstly to FIGS. 1 to 3, there is illustrated energy conversion apparatus 10 according to the present invention for converting centrifugal force into usable energy, the machine 10 including a rectangular box like perimeter frame 11 having upper and lower parallel cross arms 12 and 13 arranged centrally of the frame 11. The apparatus 10 includes an output shaft 14 supported rotatably in bearings 15 to the upper and lower cross arms 12 and 13.

Upper and lower radial arms 16 and 17 are mounted to the shaft 14 through bearings 18 and 19, the arms 16 and 17 extending diametrically and symmetrically of the shaft 14 and therefore extending radially the same distance on opposite sides of the shaft 14.

Positioned between the upper and lower arms 16 and 17 is an output gear 20 which is fixed for rotation with the shaft 14.

A pair of pedestal shafts 21 are mounted on the lower radial arm 17 to project parallel to the output shaft 14 therefrom at an equal spacing from the output shaft 14 and positioned radially in substantial alignment with the outer edge of the output gear 20. Each pedestal shaft 21 carries a reverse idler gear 22 each of which is in mesh with the output gear 20.

Respective frame gear assemblies are provided at opposite ends of the arm 17, the frame gear assemblies include frame gears 24 which are in mesh with the reverse idler gears 22, the frame gears 24 being mounted via bearings 25 to frame gear shafts 26, the frame gear shafts 26 being mounted to the upper and lower arms 16 and 17 by respective upper and lower bearings 27 and 28

The frame gear shafts 26 also carry drive gears 29 which are fixed for rotation with the frame gear shafts 26, the drive gears 29 being positioned above the frame gears 24.

Each frame gear assembly additionally includes on its frame gear 24, a pair of pedestal shafts 30 arranged symmetrically and diametrically on opposite sides of the shaft 26. The frame gear assemblies also include weight gears 31 which are mounted via bearings 32 to the respective pedestal shafts 30, the weight gears 31 being in mesh with the drive gear 29. Each weight gear 31 is weighted on one side such as by means of an attached weight 33 or by having a weight built into the gear 31 or by having the gear 31 manufactured with an offset weighting. The center of mass of the weight gears is thus radially offset from their axis of rotation. The weight gears 31 are arranged such that when one weighted side of a weight gear 31 is directed radially outwardly from the output shaft 14, all weighted sides of all weight gears 31 on opposite sides of the apparatus 10 are directed radially outwardly from the output shaft 14. The weighted sides of the weight gears 31 on one side of the shaft 14 however are arranged diametrically opposite the weighted sides of the weight gears 31 on the diametrically opposite side of the shaft 14.

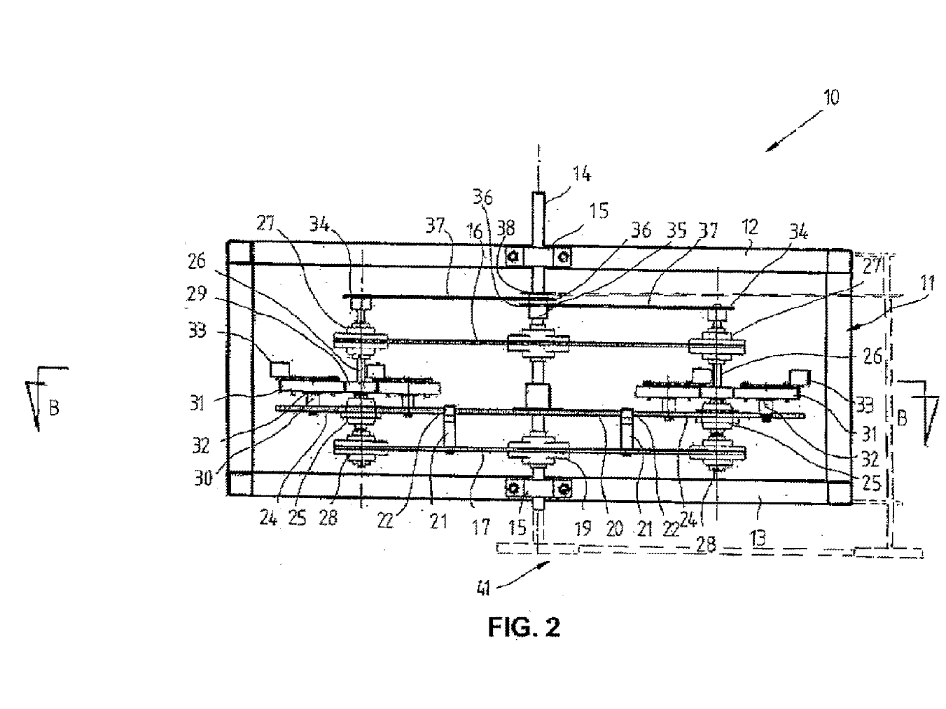

As shown in FIG. 2, the frame gear shafts 25 project at one end beyond the arm 16 and carry respective final chain sprockets 34. The output shaft 14 carries a freely rotatable collar 35 which carries respective input sprockets 36 and respective endless drive chains 37 couple the final chain sprockets 34 to the input sprockets 36.

The freely rotatable collar 35 carrying the sprockets 36 is adapted to be driven by an input drive sprocket 38 fixed for rotation with the collar 35. The input drive sprocket 37 may typically be driven by any input such as by a drive motor 39 mounted to the frame 11 and coupled via a belt/pulley transmission (or sprocket/chain transmission) 40 to the sprocket 38 (see FIG. 1). A belt/pulley chain/sprocket transmission 41 shown in dotted outline in FIG. 2 is provided to return output from the output shaft 14 to the input drive sprocket 38. Alternatively the transmission may comprise a hydraulic or hydrostatic transmission. As an alternative to the sprockets and chains, belts and pulleys may be used for transmission of rotary motion between the respective components of the apparatus 10.

In use, the drive motor 39 is operated to apply a drive to the input sprocket 38 to start the operation of the apparatus 10 at a required revolution rate and thereafter a return from the output at the output shaft 14 can be applied to maintain this and compensate for energy losses including the non-recoverable losses of friction within the machine 10.

When a clockwise drive is initially applied by the motor 39 to the input sprocket 38, drive is conveyed via the drive chain 37 and final drive sprockets 34 to the frame gear shaft 26 and thus to the drive gears 29.

At lower speeds, rotation of the drive gears 29 will cause rotation of the meshing weight gears 31 on their pedestal shafts 32 and thus cause rotation of the frame gears 24 about the frame gear shafts 26. The meshing of the frame gears 24 with the idler gears 22 which are in mesh with the output gear 20 will cause orbiting movement of the frame gear shaft 26 and the frame gears 24 thereon and rotational movement of the radial arms 16 and 17 in a clockwise direction around the output shaft 14. As the speed of rotation of the frame gears 24 increases, the centrifugal force exerted by the weights 33 of the weight gears 32 will effectively lock the frame gears 24 against rotation relative to their shafts 26. The chains 37 will now act as rigid arms between the input drive sprocket 38 and the final chain sprocket 34 and rotate around the output shaft 14 with the arms 16 and 17 at a rotational power equal to the input power applied by the motor 39. As the frame gears 24 are now locked against rotation but continue to orbit around the output shaft 14, their meshing with the idler gears 22 will causes rotation of the output gear 20 in a clockwise direction, this being in addition to any flywheel effect with stored maintenance energy due to the weighted frame gear assembly being positioned at a radius from the output shaft 14. This comprises the first of two driving forces applied to the output gear 20 and thus to the output shaft 14. In addition a centrifugal force is generated in the frame gears 24 due to their rotation about the shaft 25.

The rotational driving of the frame gear shafts 14 from the drive motor 39 also continues to drive the drive gears 29 which results in an anticlockwise rotation of the weight gears 31 which causes the weights 33 carried by the weight gears 31 to rotate anticlockwise within the frame gears 24. Due to resistance to spin by the frame gears 24 an amount of overspin or advance of the weights 33 past the most outward line from the output shaft 14 will occur. Resistance is due to force required to maintain the angular momentum of the frame gear components, friction and any retarding effort on the output shaft 14 from the drawing off of energy for external use and/or returning as the maintenance drive to the input drive sprocket 28.

As the weighted side of the weight gears 30 rotate, the centrifugal force acting on them will cause the rotation of the frame gears 24 to synchronize and match the rotation of the weight gears 31. When the weight gears 31 are rotated to carry the weights 33 anticlockwise, the effective center of mass of the frame gear assembly which is governed primarily by the position of the weights 33 will be located anticlockwise relevant to a radial line extending from the output shaft through the axis of rotation of the frame gears 24 irrespective of the rotational speed of the frame gears 24. The position of the center of mass however will vary due to friction or load drawn from the output shaft 14.

With the weights 33 in advance, the effective center of gravity or mass of the frame gears 34 moves anticlockwise, such that the centrifugal force acting through the effective center of gravity or mass of the frame gears 24 which are not in line with, but advanced ahead of the radial arms 16 and 17 will cause the frame gears 24 to rotate clockwise due to an applied torque movement about the frame gear shafts 25. The clockwise rotation of the frame gears 24 is transmitted through the idler gears 22 to the output gear 20 and comprises a second driving force applied to rotate the output gear 20 clockwise.

Since the revolution rates of both forces are tied to the revolution rate of the weight gears 31, the second force can add to the first “flywheel” force without altering the output RPM, provided that the gearing is matched, thus compounding the output force by the strength of the second force at any given frame gear revolution rate induced by centrifugal force on the weight gears 31, since the output force is not directly proportional to the input force (although governed by it) but rather to the centrifugal force which accords to the formula F=WRn2/2933
where F=centrifugal force in pounds
W=weight of added weights to drive gear in pounds
R=Radius as per length of radius arms in feet
n=Revolutions per minute of drive gears

The gearing of the apparatus can be considered at two levels, the first level being the input gearing which includes the start-up and/or maintenance source to the input as referred to above. It also includes the gearing of this to the input drive sprocket 38. The first gearing level should maintain a set ratio of input to output and this can be varied to suit a particular application although allowance may be necessary when returning power to the input through the return transmission 41.

The second level of gearing is the output gearing between the input drive sprocket 38 and the output shaft 14 which has two trains or linkages as referred to above. Within the second level of gearing, the first force can be considered as a one to one gear ratio as no spinning or rotation need occur between the components for the transmission of that force, the frame gear 24 being locked against rotation.

While the gearing of the second force must be calculated as the gearing to the weight gear 31, (being considered as though it was a gearing to the frame gears 24, this is because under operating revolutions, centrifugal force makes the frame gears 24 rotate as one with the weight gears 29) plus the gearing from the frame gears 24 to the output shaft 14 via the idler gears 22 and output gear 20.

Whilst the rotation of the output gear 20 is shown in the drawings to be conveyed via the output shaft 14 to return energy to drive the input drive sprocket 38 by direct drive, a variable mechanical drive, or any other means such as hydraulic or electric drive systems may be used to drive the input sprocket 38 from the output shaft 14 so as to maintain the operation of the apparatus 10.

All gearing must be configured to suit the method of maintaining the input power when diverting any of the output to the input. If returning power is by direct invariable mechanical linkage, the gearing of the second force must be at a one to one gear ratio, since a given output rpm is produced from a given input, two different input revolution rates cannot simultaneously occur. This means that if an invariable output rpm is to be returned to the input, it must be at the reverse ratio of the input to output production.

Given that any increase in revolution rate of the radial arms produces a four-fold increase in centrifugal force applying to the weights, it follows that the second force applied by the apparatus 10 will accordingly increase its contribution to the rotation rate of the output gear 20. Further at any given input rpm, the more the final, chain sprocket 38 rotates (in contrast to non-spin that applies the first force rotation of the frame gears) in response to resistance to the input torque so as to drive the weights to advance can alter the contribution of the second force in its substitution for the first force. This substitution must be on a one for one gearing ratio or it will cause a varying in input to output ratio that will trigger internal tensions that drain energy or even cause breakage, if return of power is not controlled as by variable systems.

While the principles of generation of the second force apply to any different configurations of apparatus, a different balance of contributions from the first and second output forces may result, since any variation in the balance in total frame gear mass and the mass of the weights will change the dynamics of each, because the energy to supply to or extract from both flywheel and centrifugal forces varies with mass, radius and gearing.

The input force at any given time is expressed against the weight gears and applied at the tangent of the weights arc. This can be calculated from the angle forming the vector of the line of the centrifugal line and the tangent line from the weights, and this multiplied by the centrifugal force applying to it (in accordance with WRn2/2933 as referred to above).

In these conditions the power from the input is expressed at the output in two ways. Firstly, with the exception of frictional forces, all the input power (as explained above) is applied to rotate the frame gears 24 with the same segment of the frame gears 24 always closest to the output gear 20. This effective lock to the frame gear 24 will apply torque to the output gear 20 in the form of kinetic, or flywheel energy. This force therefore matches the input force and is as calculated as above for the input.

Secondly, power at the output is also derived from the torque applied to the frame gears 24 by centrifugal force (being a by-product of angular momentum) applying to each of the weights 33 (as advanced from their radial line) and this is conveyed through the idler gears 32 to the output gear 20. This second force is delivered at a range of force in consequence to the range of moments caused by the amount of advance of the weights 33 from their line of centrifugal force. This can be measured since the centrifugal force of the weights 33 is expressed at all points along the centrifugal line. By multiplying the centrifugal force (WRn2/2933) by the length of a line from the point adjacent to the center of the frame gear 24 to the center of the frame gear 24, then dividing this by the radius of the frame gear 24 gives the moments of torque applied to the idler gear 22 and from the idler gear 22 to the output gear 20.

Since the second force is a consequential force resultant from the advance of the weights incumbent in the balance of the first forces, all this output less frictional loss is gain, and so can be used to power external applications.

While it is the second force that uses centrifugal force to achieve the additional output, for this to happen, the angular momentum of the first force must be maintained. This is best achieved by arranging the common gearing of the two forces, such that the final drive gear 29 has a step up gearing to the weight gear 31 with this compensated by a step down from the frame gear 24 to the output gear 20 so as to maintain the one to one gearing between the two forces.

With this configuration comparatively more resistance to the input will be met by the second force when being conveyed from the frame gear 24 to the output, while not affecting the force required for angular velocity in the first force. Resultant from this, the essential angular velocity of the first force will not be reduced when output energy is drained off.

If centrifugal force is not strong enough to restrain the weight gears exceeding an advance of 900 to their line of centrifugal force (due to the apparatus not being run fast enough or more power being drained off from the output than is surplus) the torque supplied by the weights will diminish to the 1800 point and thereafter act in reverse, causing the output gear 20 to decelerate, with the maximum deceleration occurring at 2700 when the decrease in rpm of the frame gear 24 will be a negative rpm of 100% of the relative rpm of the weight gears 31. This will cancel the input force of the first force.

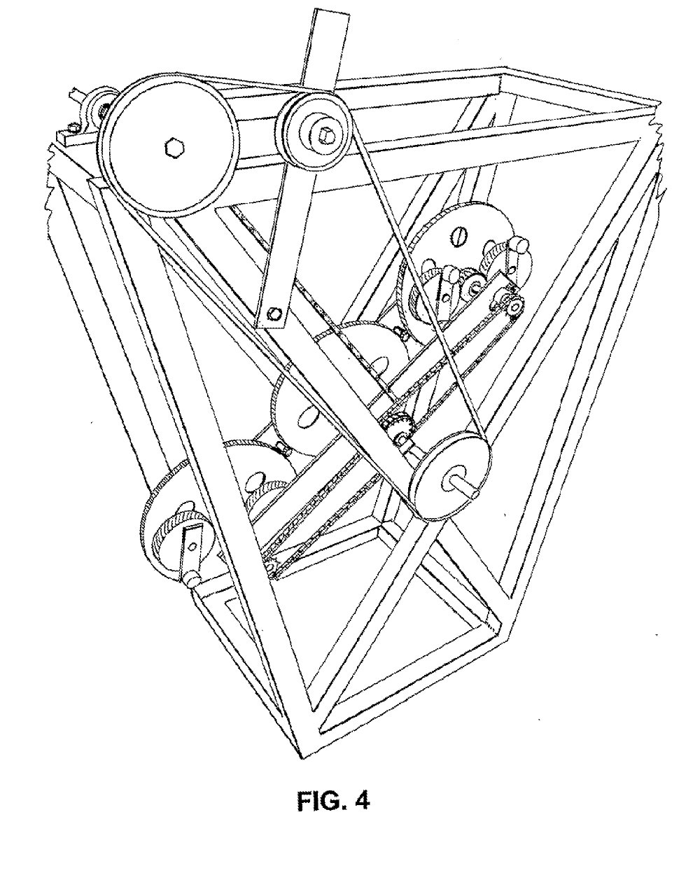

In testing of the practical embodiment of the apparatus shown in FIG. 4 and under constant slowly run electric motor input, the weights 33 can be seen to advance 450 on their arc when hand pressure resistance is applied to the output shaft 14 and when removed the weights return to full extension of the radius.

Using a photo tachometer D-2236 to measure the rpm of various components, with a digital camera recording the reading on movie mode, and these readings transcribed to a spread sheet and converted to a chart, conformation of the two forces have been shown.

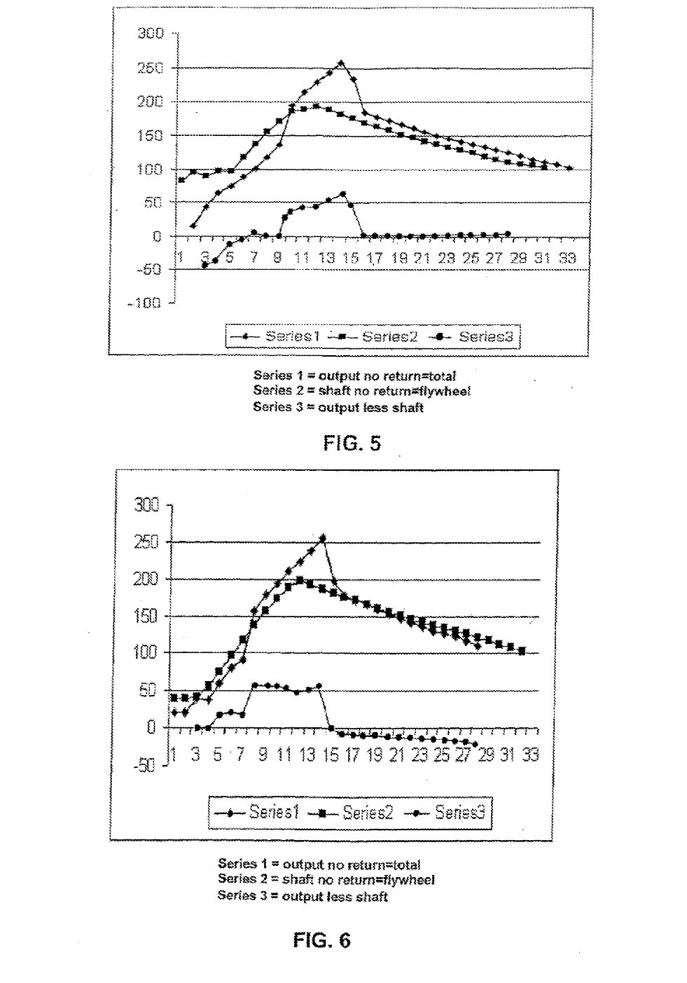

With the apparatus powered by a 650 W electric drill various charts were formulated using Microsoft Office Excel 2003 as illustrated in the charts of FIGS. 5 to 15 which in each case show variations in output RPM (vertical axis) over time (horizontal axis). Each chart formulation process was duplicated to confirm the reliability. It was shown by the above testing that:

1. The second force i.e. produced by cranking centrifugal force has been applied.

2. The output force from apparatus is not stored kinetic energy from the flywheel effect.

3. More output is delivered than input is applied.

FIGS. 5 and 6 show the charting of separate forces with the input only powered by the electric drill with respective charted lines showing total output, the output due to the first force and the output due to the second force. The rpm of the output shaft was recorded while input force was applied, with peak rpm of 255.7 & 257.9 at which point input force was withdrawn. The chart then shows a sudden two refresh interval drop of rpm to 177.7 & 184.5.

When this is compared with the charts of the rpm of the radial arms 16 and 17 (being the rate of revolution of the frame gears 24 mounted to the arms 16 and 17) which show a peak rpm of 193.3 & 197.5, a difference in peak rpm between the radial arms and the output is revealed, 255.7 less 193.3=62.4 and 257.9 less 197.5=60.4 which can only be explained by the addition of rpm from the second force, due to the centrifugal force applying on the weights 33 as they are advanced by the input and amplified by the gearing differential between the frame gear 24 and output gear 20.

Once the drill's input was withdrawn, and in the absence of a return of the output power to the input shaft, and thus no drive to the input shaft to create the second force, the sudden two refresh interval drop of rpm to 177.7 & 184.5 is in response to the only remaining force left, the kinetic flywheel energy, which then gives the steady reduction in rpm as seen in all four charts of no return, tapering down to the 100 rpm rate. Below 100 rpm the centrifugal lock of the frame gears can give way causing the frame gears to spin and so no longer drive the output gear with the flywheel effect.

The additional energy supplied by the weights under centrifugal force responsible for the increase in rpm of 255.7 minus 193.3=62.4 rpm or 32.3% (see FIGS. 5 and 6) and 257.9 minus 197.5=60.4 rpm or 30.5% is particularly significant as it comes on top of the input force as applied to the flywheel energy, and as such requires exponentially greater energy (E=[½] MV2).

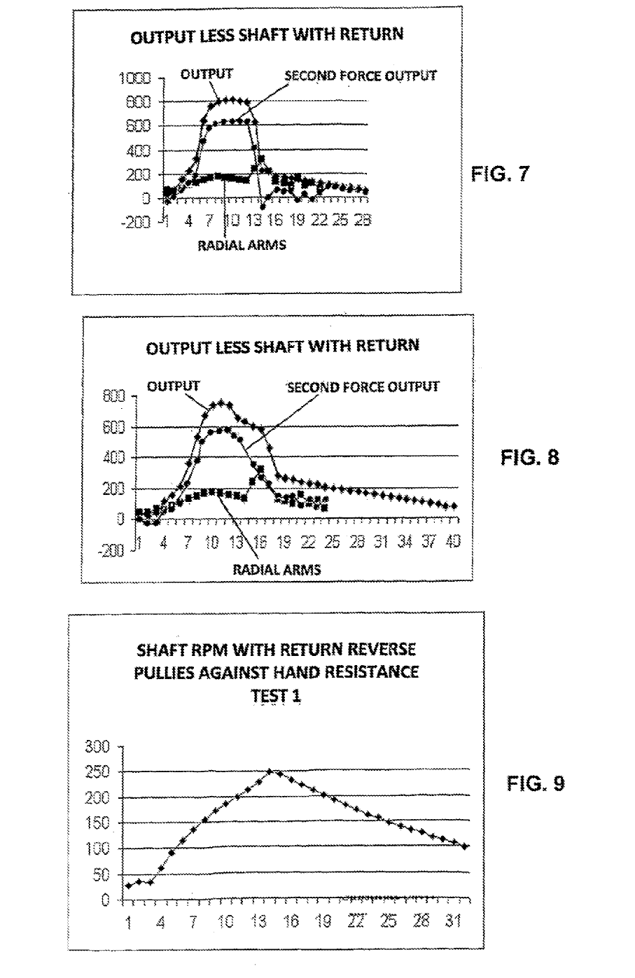

When output power was returned to the input by direct belt drive, the additional energy supplied by the weights 33 under centrifugal force responsible for the increase in rpm of 813.6 minus 157.1=656.5 rpm or 417.8% (see FIG. 7) and 748.5 minus 165.1=583.4 rpm or 353.3% (see FIG. 8)

Further tests showed that output power does not come from the kinetic, or flywheel energy alone. This is shown in tests recording the radial arms rotation, while the output is under strong hand resistance load. Irrespective of whether power was being returned to the input or not, all tests in both configurations showed that there was no drop in rpm of the radial arms while the resistance was applied. There was however a drop in rpm of the output shaft 14 which could only be a reduction of the second force attributable to the additional energy supplied by the weights 33 under centrifugal force.

The figures from the tests of the radial arms rotation during full drill input with hand resistance applications intermittently throughout were:

Radial arms with return of power from the output shaft to the input shaft (FIG. 9): constant rise from 28.1 to 249.1 when drill was removed.

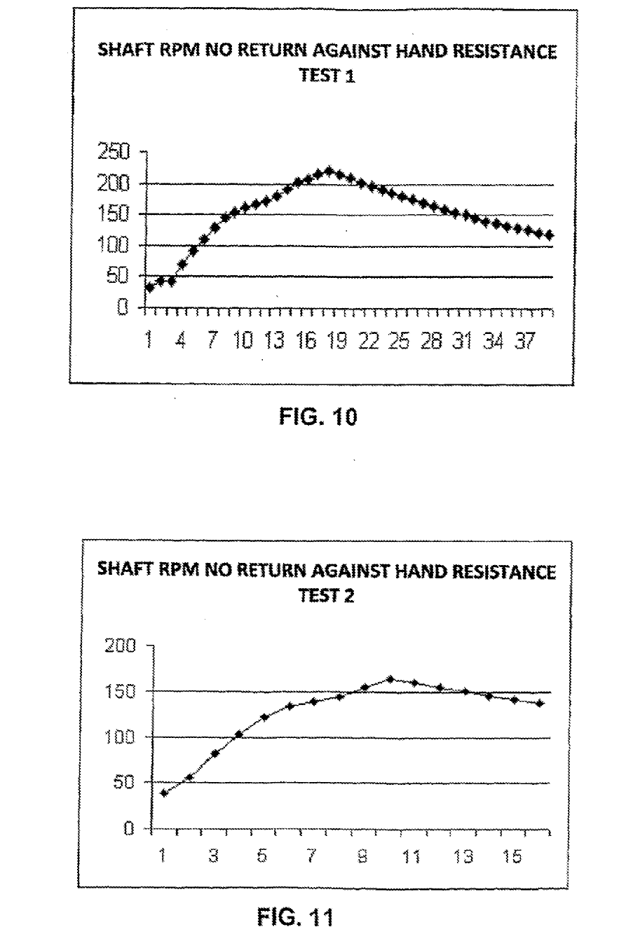

Radial arms without return of power from the output shaft to the input shaft (FIG. 10): constant rise from 32.6 to 220.4 when drill was removed.

Radial arms without return of power from the output shaft to the input shaft (FIG. 11); constant rise from 38.8 to 164.9 when drill was removed

In all cases when the drill input was withdrawn constant rpm reductions occurred.

The figures from the tests of the output shaft during full drill input with hand resistance applications intermittently throughout were:

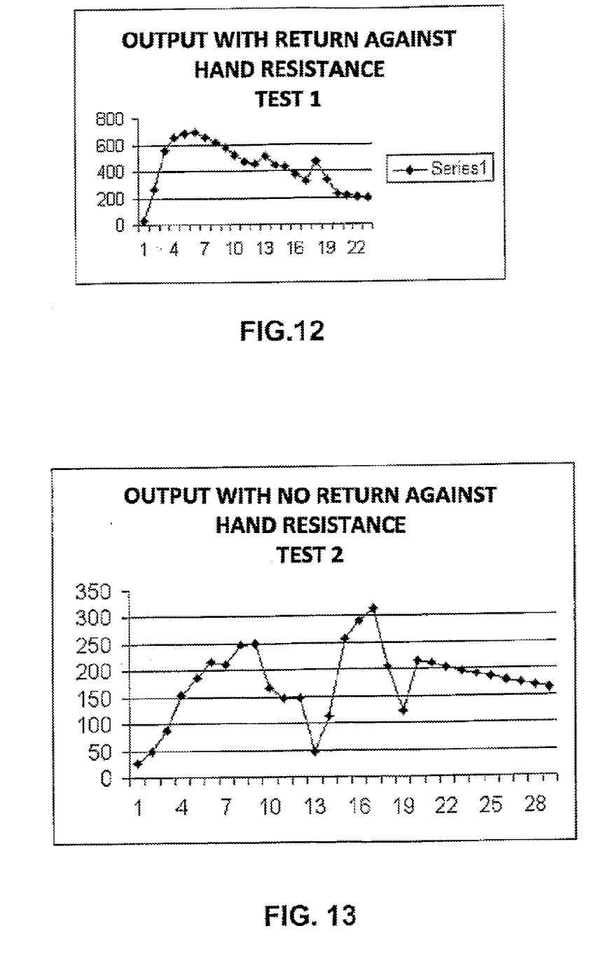

Output shaft with return of output power to the input shaft: decreases from 692.1 to 447.1 (see FIG. 12) and from 503.9 to 322.7.

Output shaft without return: decreases from 249.8 to 45.3 (see FIG. 13) and from 313.1 to 122.2

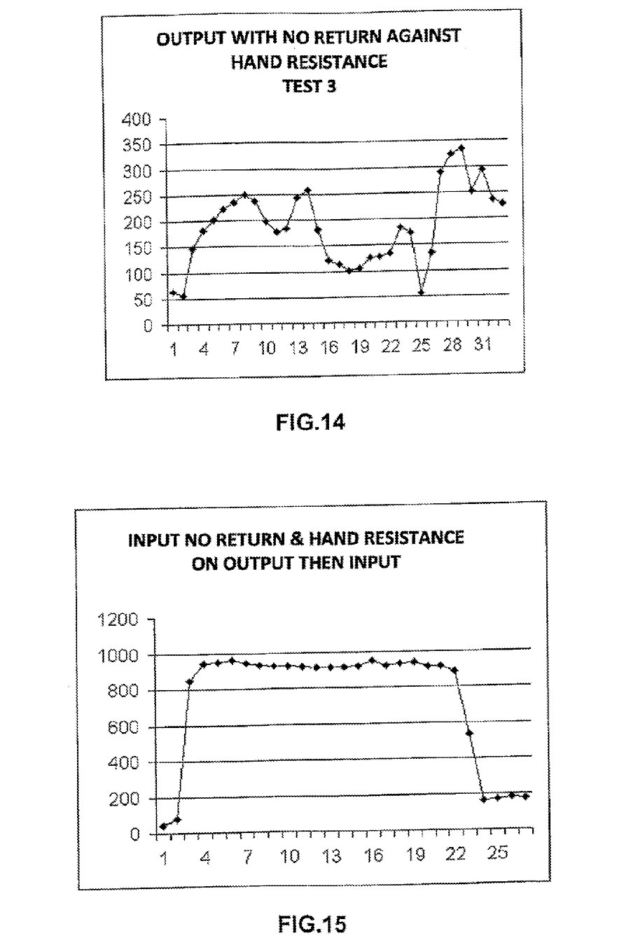

Output shaft without return: decreases from 248.5 to 178.3 (see FIG. 14) and from 258.6 to 105.7 and from 183.5 to 56.4.

FIG. 15 shows, with full power constantly applied to the drill, the rpm of the input shaft was measured without the output returned. Records show the rpm rose in one frame to 845.9 and held in the range of 845.9 to 963.1 until hand resistance was applied to the input. During this period hand resistance was applied to the output twice.

The first application was progressive commencing gently at 963.1 and increased to maximum effort at 925.3 rpm. Rpm during this progressively decreased through 963.1, 942.1, 934.2, 923.5, 925.3, 919.9, 915.7, 914.5, and 911.1 at which point hand resistance was removed and rpm rose to 948.5 when hand resistance was again applied for a short application and rpm dropped to 921.7, with hand resistance again removed rpm rose to 934.6, 915.7 and 911.2 at which time the same level of hand resistance was applied to the input shaft (with full power still applied from the drill) which slowed to 883.6, 533.6 & 162.4 at which point the drill's power was removed and rpm recorded were 162.4, 166.1, 176.2, and 170.9.

In summary, FIGS. 6 and 7 show there is an additional force driving the output.

FIGS. 7 and 8 show additional force when output is returned.

FIGS. 9-14 show kinetic flywheel force is not being drained under hand load.

FIG. 15 shows the output is a far greater force than that supplied from the drill.

Therefore since the additional force at the output does not come from the kinetic flywheel and it exceeds the power of the drill, and is compounded when output is returned to the input, it must come from the centrifugal force applying on the weights, this is the second force referred to above.

In the tests the prototype apparatus having only weights 33 of less than one pound and the radial arms only run to less than 250 rpm without return of power, centrifugal force delivered to each weight is only 11.57 kg under the formula MRN2/2933. As a prospective, if a purpose machined built apparatus were to run at 7,000 rpm with only the same weights, it would generate a centrifugal force of 7,666 kg.

The principles of the apparatus apply to any different configurations of apparatus but may give a different balance of contributions from the first and second output forces, since any variation in the balance in total frame gear mass and the mass of the weights will change the dynamics of each, because the energy to supply to or extract from both a flywheel and centrifugal force varies with mass, as well as this both of these also vary with radius.

An example of net output force resultant from the second force with the test apparatus excluding friction is; with two frame gears 24 of 7 inch radius each with weights being [½] pound and radius of weights around output of 16 inches and frame gears 24 rotating at 195 rpm and weight gears 31 centered 4[½] inches out from the center of the frame gears 24, the calculations are:

[½]*16/12*1952/2933=8.64 lbs

8.64*3/12/7/12=3.7 ft lbs at idler gear

3.7*4 weights=14.8 ft lbs

2*22/7*7/12=3.66 ft travel of frame gear teeth per spin

3.66*average rpm of frame gear spin at 75=275 ft per min

14.8*275=4075 ft lbs per min

1 HP=33,000 ft lbs per min

Therefore, the test apparatus without return power would he expected to deliver 12347 HP or approximately ⅛ HP

The same calculations applied to the test apparatus at different frame gear rotation rates compute to:

195 rpm yields ⅛ HP Given that these figures are based Therefore HP

390 rpm yields [½] HP on 1:2.6 ratio of frame gear spin could be

1560 rpm yields 8 HP to shaft rpm. Comparison of charts 18.9 HP

6240 rpm yields 128 HP1&2 imply up to 1:1.1 at higher revs 320 HP

If a test apparatus had 4 frame gears 24 with weight gears 31 7 inches out and weights 33 weighing 2 lbs still housed in the housing frame of 120 cm*120 cm*55 cm such a single unit run at 195 rpm would work out to 1.97 HP and if this was ran at 5,000 rpm the output would be 1,296 HP

After adjustment for correction for a 1:1.1 ratio the output would be: run at 195 rpm would work out to 4.66 HP and if this was run at 5,000 rpm the output would be 3064 HP.

Further multiple apparatus on the common output shaft would multiply the output. The test frame housing could have room for at least three or more mechanisms.

The input RPM rate can be adjusted via the return system.

The above is limited by structural strength and draw off of energy not exceeding one half of the total output energy, based on the calculation method above. This is because exceeding this will cause the weight gears 31 to rotate away from the line of centrifugal force beyond 900 and so diminish the leverage for the second force.

In use a drive source is applied to the input drive to start the operation of the apparatus to a required revolution rate and thereafter a return from the output can be applied to maintain this and compensate for energy losses including the non-recoverable losses of friction within the apparatus.

Drive belts and pullies may be used instead of Drive chains and Chain sprockets.

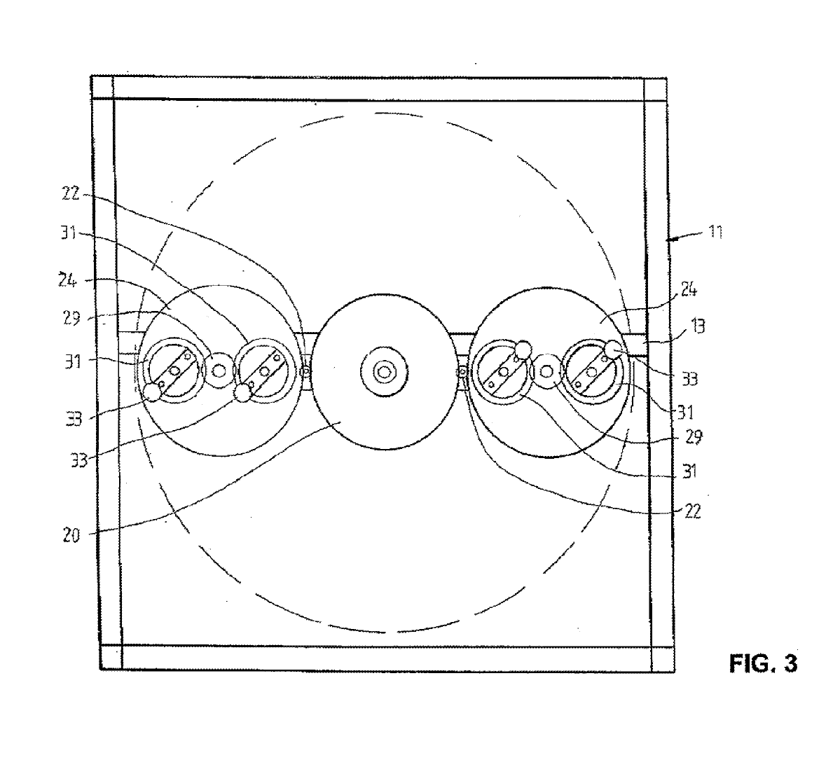

In this configuration, when viewed from the side the weight gears are mounted, i.e. VIEW B-B; (see FIG. 3). With appropriate adjustments the apparatus can be run in either direction but by way of example; when a clockwise drive is applied to the input drive sprockets 38 it is conveyed via the drive chains 37 to the final chain sprockets 34 and through to the drive gears 29 and their meshing with the weight gears 31.

The acceleration and friction of these components at start up applies resistance at the final chain sprocket 34 which will make the drive chains act as a solid causing the radial arms 16 with their components of idler gears 22 and frame gear assemblies to be induced to rotate clockwise around the output shaft 14 and so create centrifugal force to the outer components, and most relevantly the weight gears 31, so that at adequate revolutions (around 150 rpm upwards) the weights 33 are unable to spin due to the increased outward pull of centrifugal force and they are held synchronously on the widest radial line.

With the final chain sprocket 34 unable to spin there is a complete conveyance of all input (less friction) through the meshing of the idler gears 22 to the output shaft 14. This is the first force to spin the output gear 20 clockwise. Resulting from this all parts of the frame gear 24 will express greater centrifugal force as the radial arms 16 rotate faster.

If an output load is applied, an equal input is required to maintain the radial arms 16 rotation rate (note input equal to output), but the increase in tension between the input and output will cause the weights 33 to be forced past the central radial line and so transfer the centre of gravity (the line of centrifugal force) to the side of the frame gear 24 on which they are mounted and so apply torque to the frame gears 24 due to centrifugal force and so cause the frame gears 24 to spin clockwise as the weight gears 31 are turned.

The clockwise spinning of the frame gears 24 will convey the second driving force, being the product of centrifugal force (a non-input requiring by-product of angular momentum) through the idler gears 22 to spin the output gear 20 clockwise.

Depending on gearing, a mix of the two spin or revolution rates will occur, but with a one to one gearing their aggregate rate combining at the output will always be the same as the input rate.

Given that any increase in revolution rate of the radial arms 16 produces a fourfold increase in centrifugal force applying to the weights 33; it follows that the second force applied by the apparatus will accordingly increase its contribution to the rotation rate of the output gear 20. Further at any given input rpm, the more the final chain sprocket 34 rotates (in contrast to non-spin that applies the first force rotation of the frame gears 24) in response to resistance by any load applied to the output, against the input torque, it will drive the weights 33 to advance.

This is done by maintaining an added off centre weight of the weight gears 31 to one side of the frame gear 24 whilst in orbit, regardless of any spin the frame gear 24 may undergo, such that the offset mass of the weight gears 31 orbit in a manner synchronous to the centre of orbit of the frame gear 24 while they may be freely spinning in orbit.

This will increase the power of the second force while simultaneously increasing resistance to at the final chain sprocket 34 and so increasing the conveyance of the first force to the same power. Since revolution rate of the first and second force may vary, gearing must be on a one for one gearing ratio or it will cause a changing in input to output ratio that will trigger internal tensions that drain energy or even cause breakage, if return of power is not controlled as by variable systems.

While the principles of generation of the second force apply to any different configurations of apparatus, a different balance of contributions from the first and second output forces may result, since any variation in the balance in total frame gear 24 mass and the mass of the weights 33 will change the dynamics of each, because the energy to supply to or extract from both the conveyed force from the input and centrifugal force varies with mass, radius and gearing.

The input force at any given time is expressed against the weight gears 31 and applied at the tangent of the weights arc. This can be calculated from the angle forming the vector of the line of the centrifugal line and the tangent line from the weights 33, and this multiplied by the centrifugal force applying to it (in accordance with WRn2/2933 as referred to above).

In these conditions the power from the input is expressed at the output in two ways.

Firstly, with the exception of frictional forces, all the input power (as explained above) is applied to rotate the frame gears 24 with the same segment of the frame gears 24 always closest to the output gear 20. This effective lock to the frame gear 24 will apply torque to the output gear 20 in addition to the kinetic flywheel energy.

This force therefore matches the input force and is as calculated as above for the input.

Secondly, power at the output is also derived from the torque applied to the frame gears 24 by centrifugal force (being a by-product of angular momentum) applying to each of the weights 33 (as advanced from their radial line) and this is conveyed through the idler gears 21 to the output gear 20. This second force is delivered at a range of force in consequence to the range of moments caused by the amount of advance of the weights 33 from their line of centrifugal force.

This can be measured since the centrifugal force of the weights 33 is expressed at all points along the centrifugal line. By multiplying the centrifugal force (WRn2/2933) by the length of a line from the point adjacent to the centre of the frame gear 24 to the centre of the frame gear 24, then dividing this by the radius of the frame gear 24 gives the moments of torque applied to the idler gear 21 and from the idler gear 21 to the output gear 20.

Since the first force is a direct product of the input force and is fully conveyed to the output, and the second force is a consequential force resultant from centrifugal force acting on the advance of the weights 33, all the output of the second force less factional loss, is gain, and so can be used to power external applications.

Power can be increased by incorporating multiple frame gears 24, weight gears 31 or the use of modified weight arms whereby instead of these being attached to the weight gears 31 which in turn are mounted by bearings to pillars, the weight gears 31 can be mounted on shafts extending through the frame gears 24 and mounted on bearings such that the non-gear drive side could also have a weight arm attached. With the weights 33 balanced a more even load would be applied to the frame gears 24 while increasing the mass of the weights 33 and so the power. Further multiple apparatus 10 on a common output shaft 14 would multiply the output. The test frame housing could have room for at least three or more mechanisms.

Multiple apparatuses 10 may be run in series for any reason such as, only needing one low capacity controlled differential coupling (explained in more detail below) to be installed on the first of the series coupled apparatus 10, so that power control of the, or all downstream apparatuses 10 can be made from the one low capacity controlled differential coupling without the need to install Controlled differential coupling to any other apparatus 10.

In order to self-power or recycle some of the energy from the output to supply power to the input, the spin of the output gear 20 can be conveyed via the output shaft 14 to return one half of output energy to drive the input drive sprocket 38 of any apparatus 10 by direct or variable mechanical drive, or by any other means such as chain, hydraulic or electric drive systems, so as to maintain the system. All gearing must be configured to suit the method of maintaining the input power when diverting any of the output to an input.

Gearing of the apparatus can be considered at two levels, the first is the gearing from the input drive to the rotation of the radial arms 16, 17, and the second the gearing from the input drive to the rotation of the weight gears 31.

With a power regulator installed a lock is engaged between:
1. The output shaft rotation;
2. The rotation rate of the radial arms 16, 17; and
3. The rotation rate of the weight gears 31.

Since these are all then interconnected, all three must be geared one to one. Such a one to one gearing then allows the rotation of either the frame gears 24 or the radial arms 16, 17, or any combined rotation of them to match the output rotation that these cause at the output.

For such a one to one gearing to operate it must be noted that for each rotation of the frame gears 24, the weight gears 31 will also do one revolution if they are meshed with a matching sized final drive gear 29, but this is in violation with the principle of the apparatus 10 which requires the weight gears 31 to always remain in the same quadrant of the frame gears 24 in relation to the output gear 20 (rotate synchronously) so gearing must be appropriate.

On the working model the gearing is;

| ITEM | number of teeth |
|---|---|
| Weight gears | 46 |
| Final Drive Gear | 30 |
| Frame Gear | 120 |
| Output Gear | 120 |
| Final Drive Sprocket | 15 |
| Multiple Chain Sprocket | 38 |

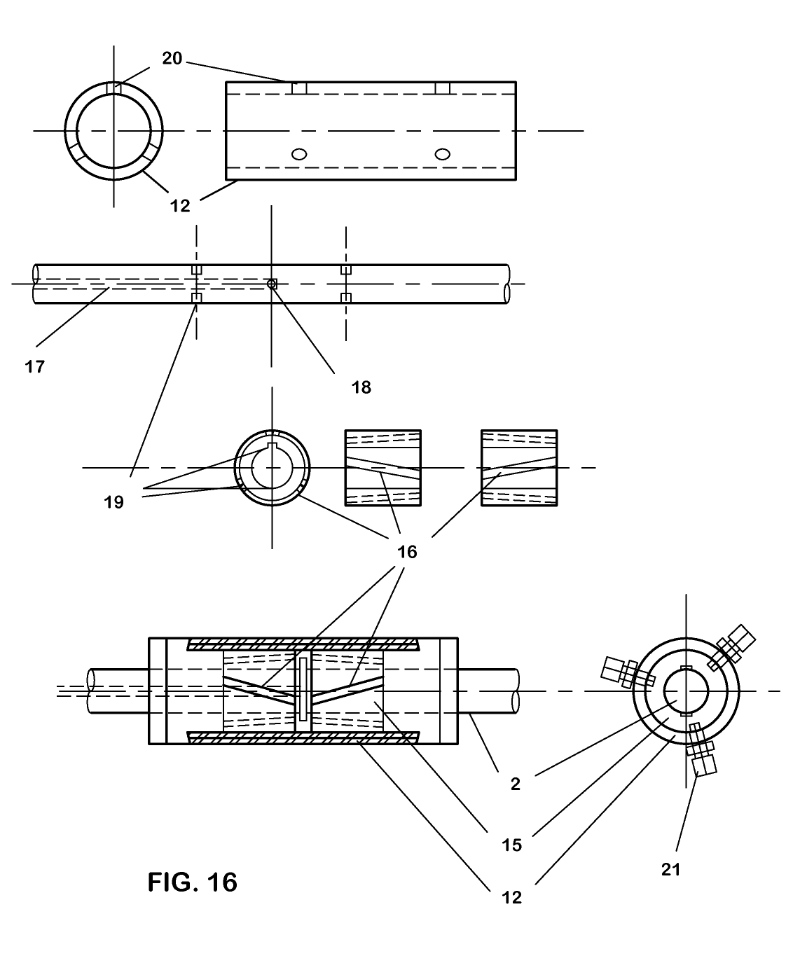

FIG. 16 illustrates a preferred method and apparatus for returning output energy by a controlled differential coupling which connects the output shaft 14 to the input in a manner that provides controlled differential coupling, so as to control the amount of off set of the gravity/mass within the rotating gear, by varying the advance of the weights 33 from the radial line and so vary the torque energy generated by centrifugal force.

FIG. 16 show the detail of this variable coupling which is actuated by variable hydraulic pressure through a rotary coupling and which causes the two helical slotted piston couplings (HSPC) 15 to move apart, thus causing rotational variation between the output shaft 2 and the input at the multiple drive sprocket (MDS) 12. This is done by connecting the output shaft 2 to the input in a manner that provides controlled differential coupling so as to control the amount of off-set of the gravity/mass within the rotating frame gear 24, and so vary the energy generated.

Located within the MDS 12 are two HSPC 15 which are slid over the output shaft 2, and free to slide horizontally, while restrained from rotation by horizontal internal slots 19 which accommodate drive pins extending out of the output shaft 2.

Helical slots 16 are located on the external barrel of the pistons 15 in opposing directions and accommodate drive pins extending in from the MDS 12 such that when the HSPCs 15 are centrally inserted within the MDS 12 with lateral retaining thrust stoppers or collars installed on the output shaft to maintain the output sprocket alignment and with a hydraulic pressure line created from an external pump via a rotary union to variably pressurize a drilled oil line 17 inside the input shaft with an outlet 18 between the two HSPCs 15 which have appropriate seals; increase in pump pressure applied through a rotary union coupling causes the two HSPC 15 to move apart causing the helical slots 16 to rotate the drive pin threads 20 in each HSPC 15 to make available rotational variation in the direct drive coupling from the output shaft 2 to the input at the MDS 12 so as to control the amount of off-set of the gravity/mass within the rotating gear, by varying the advance of the weights from the radial line and so vary the torque energy generated by centrifugal force.

With drive transferred from the output shaft 2 to the input through the drive pins, the helical angling of the outer slots means that for separation and the additional rotation that occurs, requires hydraulic pressure between the two pistons 15, which when removed will cause the pistons 15 to slide together and so reduce or remove the rotational advancing and the powering that causes such that the apparatus 10 power can be reduced or stopped. Springs may be installed against the stoppers to assist return of the HSPC 15 when hydraulic pressure is reduced to reverse rotational advancing.

The rate of change in advance can be built into the system by shaping the helical slots 16 to any curved shape such that a constant rate of increase in hydraulic pressure will advance the outer tubular shaft 34 proportionally to the curved shape.

Since the apparatus 10 can be run in either direction the HSPCs 15 should be fitted so that the helical slots 16 form the head of an arrow pointing in the direction of rotation, then separation caused by the application of hydraulic pressure will give differential rotation that causes the weight gears 31 to advance suitably for the direction of operation.

When assembling the HSPC 15 the relative rotational connection can be random. But rotational connection from the output to the input is critical. This is set when connecting the drive chains. With the HSPC 15 resting together the drive chains must be installed to connect the MDS 12 with the final drive sprocket 34 in such a manner that the weights 33 are held at neutral to slightly retarded. This is necessary for depowering the apparatus 10.

At this setting apparatus 10 can be started by an external power supply such as a starter motor applied to the MDS 12 or the output shaft 2 since this is locked to the MDS 12 by the controlled differential coupling, and when operating revs of the radial arms 16, 17 are reached (generally 100-250) the pump can be activated to gradually increase the hydraulic pressure and monitored by the pressure gauge so as to advance the weights 33 to the point that the apparatus 10 increases rpm at the output. At this point the starter motor should be turned off or disengaged leaving the apparatus to self-power or recycle power to the input.

When any extra output power is required, hydraulic pressure should be increased so as to increase the advance of the weights 33 causing the second force to proportionally increase, and so provide the power needed for the added output load and maintain the increased input need to power the apparatus 10.

The self-powering apparatus is also known as a variable power hydraulically controlled returning apparatus or a power regulator, or as above a controlled differential coupling for maintaining, increasing, reducing or stopping the power transmitted from the output to the input, and is incorporated within the multiple chain sprocket. The Power Regulator return system is the most efficient method of returning maintenance power at around 100%.

A power monitoring sensor should be fitted to regulate the power. Such a sensor may include a pressure gauge on the hydraulic power control line. This pressure is directly proportional to the advance of the weights 33, as measured as horizontal deviation from the radial line, and this is directly proportional to the power required to advance the weights 33, which in turn is proportional to the power output.

Care must be taken to not increase the hydraulic pressure too much, such that rpm continue to increase. If such rpm increase does occur the hydraulic pressure must be instantly reduced to prevent a potentially very dangerous exponential increase in self powering of the apparatus 10. A suitable pressure release system may be installed for this function.

In this configuration the operational equipment for the apparatus 10 would be:
1. A starter motor;
2. A power regulator system (via the hydraulic pump):
   a) By increasing hydraulic pressure; and
   b) By releasing hydraulic pressure;
3. Two power monitor systems:
   a) Pressure gauge;
   b) Rev counter.

Whilst the embodiment of the invention has been described in relation to use of offset weights 33 on rotating weight gears 31 for rotation of the center of gravity of the frame gear 24 around the center of the frame gears 24, alternative or additional means may be used for this purpose. For example the frame gear's 24 center of gravity could be made to rotate under centrifugal force in response to the addition of mass by the flow of a fluid through one after another of a series of ducts which radiate out around the frame gear 24 from a circular gate or manifold at the center of the frame gear 24 so as to connect the flow of a liquid to one strategically aligned duct after another. The connection could be made when a radial duct is just approaching the lead rotational direction of the frame gear 24, and this duct's connection closed (as the next is connected) and then vented by vents on the circular gate or manifold before that duct reaches the trailing direction of the frame sear so as to allow discharge of the fluid.

The circular gate or manifold could be connected via a pipe line system incorporated in the frame gear shaft 26 from one or both radial arms 16 and 17 from the Output shaft 14 with this connected to a fluid supply or sump.

Such a fluid supply could be recycled within or come from a raised supply as in a hydroelectric power station, where the system could be used in place of or in line with a turbine.

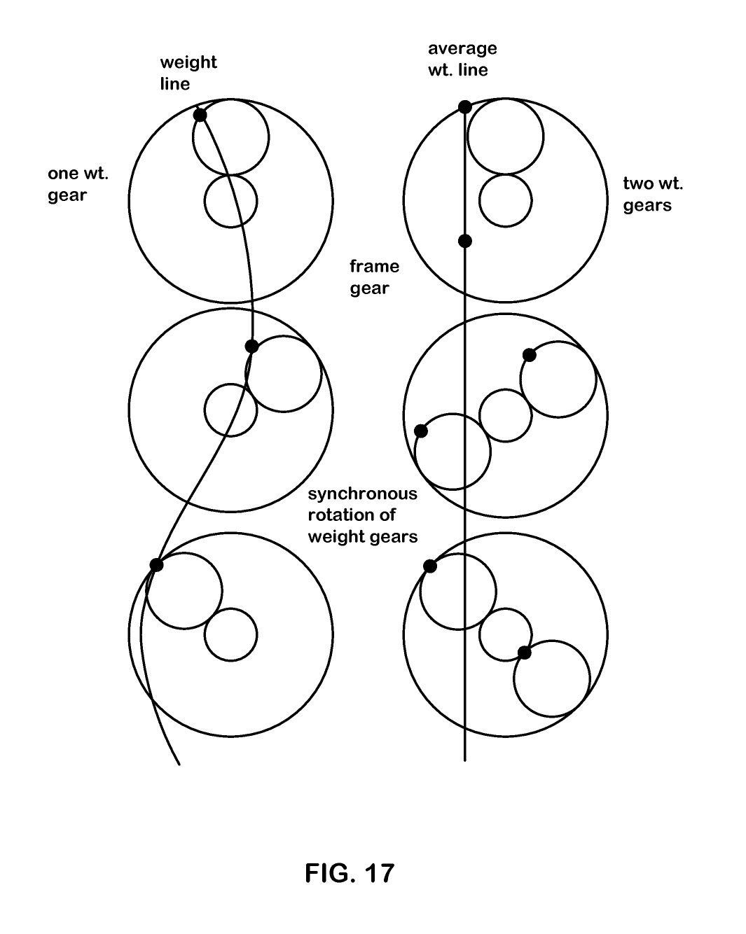

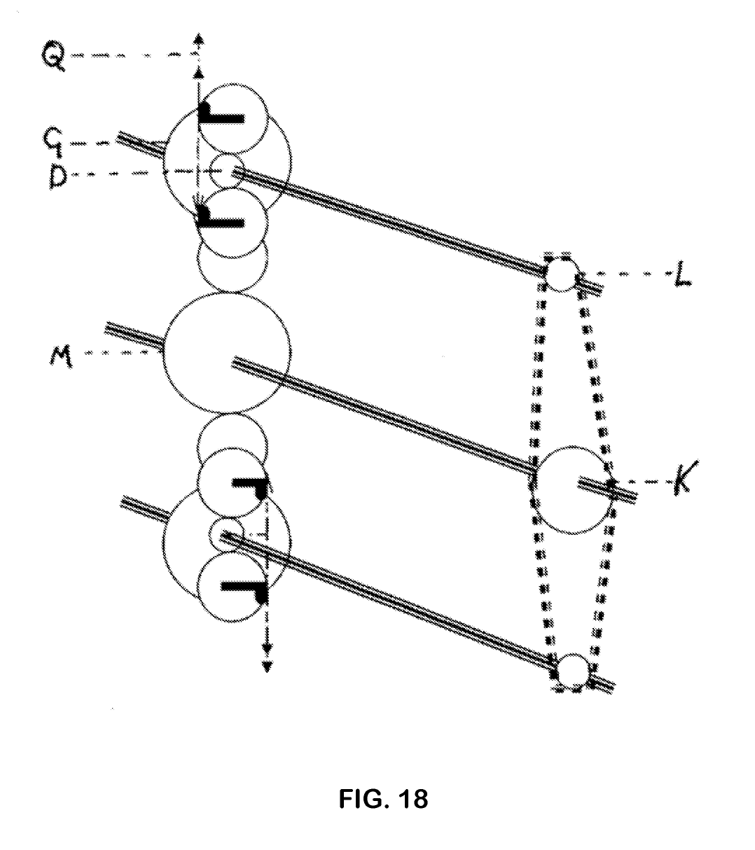

FIG. 17 Shows the effect of synchronous rotation of the weights relative of the radial line which maintains a constant weight offset when the frame gear 24 is spun when two weight gears 31 are used unlike if only one weight gear 31 was used.

### Test Results

It is undeniable that rotating weights spinning around a central point exert a continuous outward force as can be seen in the operation of a centrifugal clutch where brake pads are spun and so pushed out against the inner face of a drum with a force that creates friction to lock the inner rotation to the outer drum. There are many other examples of the use of centrifugal force such as speed regulating governors, the pivoted lawn mower blades and the centrifuge. Every serious engineering book gives the formula for centrifugal force as mass times velocity squared divided by the radius multiplied by gravity, or a derivation of this formula.

The apparatus 10 uses the same principal as spinning weights with continuous outward force, but instead of applying friction the outward force for friction, it applies torque to a rotating gear which is then transmitted to the output via the idler gears 21. The novelty of the present invention is that the weights 33 are held synchronously to one side of the outer gears or the frame gears 24. It is in the specific gearing that the weights 33 are maintained synchronously no matter what component is rotated.

The present invention has been tested using the following combination of components:

| ITEM | NUMBER OF TEETH |
|---|---|
| Weight Gears | 46 |
| Final Drive Gear | 30 |
| Frame Gear | 120 |
| Output Gear | 120 |
| Final Drive Sprocket | 15 |
| Multiple Chain Sprockets | 38 |

To show that input revs are always the same as the output revs no matter what the input revs of the multiple chain sprocket, provided the weight gears do not spin (not spinning means the weights are always farther away from the output shaft than are the unweighted end of the arms that hold the weights to the weight gears even when the frame gear spins. This is synchronous rotation of the weights as they are rotated around the output shaft carried on the frame gear regardless of whether the frame gear is spinning).

As shown by reference numerals in FIG. 18, if the multiple chain sprocket is given exactly one turn from point K through 360 degrees back to point K, and the final drive sprocket does not turn but stays at point L ie at 3.00 O'clock as viewed synchronously relative to the output shaft when viewing the frame gear being at 12.00 O'clock. Thus one turn of the input (multiple chain sprocket). The final drive sprocket and the radial arms on which they are mounted must rotate one revolution.

If the multiple chain sprocket is given exactly one turn from point K through 360 degrees back to point K, but the radial arms are not allowed to be rotated and the weight gears cannot spin because they are held outwards by centrifugal force, then:
The 38 teeth turn of the multiple chain sprocket, turns the final drive sprocket 38/15 of a spin. This is 2 8/15 spins.
This spins the final drive gear of 2 8/15 spins of its 30 teeth delivers 38/15 times 30=76 teeth advance.
This is meshed with the 46 teeth weight gears which are mounted on the frame gear.

If the weight gears were locked onto the frame gear (which they are not) then one full turn of the final drive gear would spin the frame gear. This is a 30 teeth advance of the final drive gear's teeth. Since the weight gears are free to spin synchronously then each time the frame gear does one spin the weight gears must also spin one revolution relative to the frame gear. This is 46 teeth. This requires a total of 30 plus 46 teeth advance that is 76 teeth advance of the final drive gear. This is exactly the advance of the final drive gear teeth as shown above.

Therefore since one turn of the input through the radial arms equals one turn of the output, and one turn of the input through the frame gear spin equals one turn of the output, any combination results in one input revolution giving one revolution of the output.

In order to test the hypothesis that the apparatus amplifies an input force to a doubling of the force or force amplification at the output we will follow the flow of the forces mechanically through apparatus using units of force in their newton vector of their torque and as newton meters (Nm). These forces and their flow can be measured as follows, using newtons (N) as units of force and their direction indicated as “cw” for clockwise and “acw” for anti-clockwise. Radii are distinguished as “D” in meters (m). Capital letters in italics designate the point of force on the tangent of that component as listed below and normal capital letters in the calculations are for force in newtons (N).

In the model where the apparatus is at operating revs with the radial arms rotating at 159 rpm cw (Please note that rpm is an adjustable selection for operation). Centrifugal force holds the weights in the outer quadrant no matter what positioning or spin is applied to the frame gears, enabled by their synchronous gearing; this enables the conveyance from D to G.

The weights are of 1 kg mass each equal to a force of 9.8066 N each and located on the circumference of the weight gear, accordingly one side has a total of 19.6133 N. When an input is applied to the tangent of the outer edge of the multiple drive sprocket at K of 2961.87 N cw and an acw output load is applied to the output gear of 562.755 Nm which provide the following torque at their respective radii.

Input 2961.87×0.19=562.755 Nm

And a matching output torque acw is applied to the output gear of 562.755 Nm.

Please also note that the above and following calculations are only for one side for simplicity as the other side is a mirror image.

This provides the following force at their respective radii.

| | | SYMBOL | SYMBOL | DIAM- | |
|---|---|---|---|---|---|
| | TEETH | FORCE | DISTANCE | ETER | RADIUS |
| ITEM | NO | AT | AT | (cm) | (m) |
| Weight Gears | 46 | Q | Q | 23 | 0.0115 |
| Final Gear | 30 | D | D | 15 | 0.075 |
| Drive | | | | | |
| Frame Gear | 120 | G | G | 60 | 0.3 |
| Idler Gear | 60 | | | 30 | 0.15 |
| Output Gear | 120 | M | M | 60 | 0.3 |
| Final Drive | 15 | L | L | 15 | 0.075 |
| Sprocket | | | | | |
| Multiple Chain | 38 | K | K | 38 | 0.19 |
| Sprocket | | | | | |

Input at K of 2961.87 N cw from an Electric Motor Conveyed to the Output

This is the 1^{st} Force

This is conveyed by the drive chain to L as

L=K×K÷L

961.87×0.19÷0.075=7503.4 N at L cw

Expressed at D cw

D=L×L÷D

7503.4×0.075÷0.075=7503.4 N at D cw

This is conveyed to Q acw against centrifugal force

Q=D×D÷Q

7503.44×0.075÷0.115=4893.52 N at Q acw

180° Rotational pull against centrifugal force must=centrifugal force

Therefore for free to rotate weight gears to balance centrifugal force must=4893.52 N at Q cw.

This is conveyed to G being the outer edge of the frame gear G

G=Q×Q÷G

4893.52×Q÷G=G

4893.52×0.115÷0.3=1875.85 N cw at G

G conveyed to M via the idler gear

1875.85×G÷M=M

1875.85×0.3÷0.3=1875.85 N cw at M=a torque of 562.755 Nm

Which is equivalent to an input force at K cw of:

K=M×M÷K

K=1875.85×0.3÷0.19=2961.87 N at K at 0.19=562.755 Nm

This is the same as the input. This is the input fully returned once conforming to the law of conservation of energy, and so prevents any reverse or acw turning of the output gear by balancing the output load to the input. There is however some frictional losses which cannot be quantified but are no more significant than any mechanical device, and relative to the centrifugal force as calculated is insignificant, but in the case of this device they are actually mostly offset by the mechanics of the second force as appraised below. This is because friction through the gears tends to hold the weights more acw and so increase the distance from the radial line of the weights and so add to the second force.

An alternative train of force for conveyance of the input which eliminates most friction is the rotation of the radial arms, due to the resistance to spin of the final drive sprocket all torque at the input is applied by the drive chains to the final drive sprockets so all input torque is applied to rotating the radial arms which being bound to the output gear applies output rotational torque equal to the input to the output gear. This is the input fully delivered once

Calculating the Force at the Edge of the Output Gear Resulting from Centrifugal Force on the Weights. This is the 2^{nd} Force

At this point the weights express centrifugal force from their rotation about the central point of rotation of the radial arms, this being the output shaft calculated as follows.

Centrifugal force (F)=mv²÷r

Circumference c=2 π r

Taking the average radius (distance) of the weights from the centre of rotation around the output shaft as M+circumference of idler gear+G

Radius=0.3m+(2×0.15)+0.3=0.9m.

c=2×22÷7×0.9

c=5.657 m

v=c×rpm÷60 in m/s

v=5.657×159÷60

v=14.985 m/s

Centrifugal force on weights=m×v²÷r

Centrifugal force=19.6133×14.985×14.985÷0.9

Centrifugal force=4893.5 N at Q cw.

Q expressed at G

G=Q×Q÷G

4893.5×0.115÷0.3=1875.85 N at G

G conveyed to M via the idler gear

M=G×G÷M=M

1875.85×0.3÷0.3=1875.85 N cw at M or 562.75 Nm

Being the same as the input force at K cw of

K=M×M÷K

K=1875.85×0.3÷0.19=2961.87 N at K at 0.19=562.75 Nm

This is the input fully delivered a second time.

This applied to the weights at a distance of 0.3 m applies 562.75 Nm.

This distance is determined by the rpm of the radial arms. A lesser rpm than 159 rpm will apply less centrifugal force and so require less distance to balance. Alternatively less output load will offset the weights to a lesser degree and so require less distance to balance. Distance being the product of the acw rotation of the weight gears.

With 1^{st} force=562.75 Nm

And 2^{nd} force=562.75 Nm

Total output=1125.5 Nm which is twice the input of 562.75 Nm.

The power amplification system was tested with the prototype apparatus driven by an electrical motor fitted with a control box calibrated in Hertz. Six inch pulleys were fitted to both the output shaft and the input motor shaft and run at 5 hertz. Amperage current as used by the motor was measured throughout as a gauge of watts used since the voltage was constant.

With the chain from the input motor to the apparatus removed the current was 3.62 amps showing the power consumption of the motor alone. With the input motor chain fitted and so running the apparatus current was 2.9 amps. Repeatedly a vigorous hand load was applied to the output pulley and the amperage dropped to around 2-2.5 amps each time.

The following assessment of what was happening is shown in the principle of operation of the apparatus is that input is amplified to the output. This means that if there is no load on the output there can be no input to amplify. Zero times a power amplification of 2 equals zero. Accordingly an output load must be applied to have amplification such that an input of 1 times a power amplification of 2=2. Amplification is the result of the weights being forced to advance in response to the stress between input and output.

| | |
|---|---|
| Motor alone drew power of | 3.62 A |
| Motor plus UE drew power of | 2.90 A |
| Therefore UE must have contributed | 0.72 A |

(Due to power amplification caused by advance of the weights due to load from the radial arm friction)

| | |
|---|---|
| When the load was applied to the output of say | 1.40 A |
| The motor drew even less power as stated above, say | 2.50 A |

### BUT

To stay at 5 hertz the motor required 3.62 and 1.4 to match the load on the output.

| | |
|---|---|
| Both combined total | 5.02 A |
| But with input current to motor down to | 2.50 A |

Amplified this is an amplification of 2.0.

A second test of the apparatus was run at 5 & 6 hertz and at each comparisons of the maximum breaking force able to be resisted by the motor running only itself (chain off) to maintain:
1. The revs;
2. Simply not stop.
   Then with the motor powering apparatus (chain on so as to drive the apparatus):
3. The breaking force required to slow output of the apparatus and
4. Stop the apparatus.

Measurements were made by applying a breaking force by sliding a steel bar over the relevant pulley and moving a pivoted end horizontally inwards to the pulley, (which acted as the fulcrum) and so increasing the frictional load and breaking power. At both hertz tests, the pivot of the bar was brought measurably closer to the pulley on the output force compared to that resisted by the motor.

This demonstrated that the prototype apparatus did amplify power.

### Further Testing to Confirm Results

The following is a summary of eight demonstrations of the validity of the claims made for power amplification by the apparatus.

Tests were conducted using two prototypes:

| | APPARATUS | APPARATUS |
|---|---|---|
| | 1 NSW | 2 VIC |
| Approximate Max Radius | 55 cm | 60 cm |
| Approximate Weight of Working Parts | 40 kg | 200 kg |
| Input to Output Gear Ratio | 1:0.947 | 1:1 |

Gravity must be an ever renewing force for any mass to remain drawn to the earth without any loss of energy as evidenced by no loss of mass. A mass which is spinning around a fixed point at the end of a tether in a frictionless state, such as in space, will maintain angular momentum without added input. Elongation forces will be applied to the tether by centrifugal force (or reaction to centripetal force). Since the tether is revolving, the tether's tension can be used as a crank. This is the harnessing of centrifugal force. When a rotational force is applied to the input of the apparatus it is conveyed to the output shaft, at the same time the revolving that transfers that force acts as a catalyst to produce centrifugal force which is harnessed to crank the output as a second application of that force, and so both forces are delivered to the output. This is input doubled at the output less friction.

With the apparatus 1 powered by a 650 W electric drill various charts were formulated using Microsoft Office Excel 2003 as illustrated in the charts of FIGS. 5 to 15 which in each case show variations in output RPM (vertical axis) over time (horizontal axis). Each chart formulation process was duplicated to confirm the reliability. It was shown by these tests that; The second force i.e. produced by cranking centrifugal force has been applied. The output force from the apparatus is not stored kinetic energy from the flywheel effect. Therefore more output is delivered than input is applied.

A static test of apparatus 1 without a return was tried, this involved turning the input ¼ of a rev by hand, simulating any input, while a flat edge was held against an advanced weight on the radial line, so as to apply a force that simulates centrifugal force and maintains the weights degree of advance. It was noted that the frame gears spun around their centre as well as rotated around the output gear. These are the second and first forces.

String lines were used to simulate the three forces of;

(a.) The input, by a rap around the input pulley in a clockwise manner.

(b.) The output, by a rap around the output pulley in an anti-clockwise manner.

(c.) Centrifugal force acting on a 90° advanced weight.

When (a.) was pulled a corresponding pull was required on (c.), to balance this (b.) had to be pulled to balance the advance of the weight.

The test was repeated six times using spring scales to quantify the input and output torque, around 6½ inch pulleys. Care was taken in each case to be sure that the centrifugal force simulation was applied to a weight that was equally extended (or advanced) and in a manner that both weights were in radial line with the central (output) shaft. Thus the input force would correlate against the centrifugal force simulation, and so replicate dynamic working forces.

Results were all in the range of 3 kg input against 5.5 kg output, through to the most strenuous test which resulted in 6 kg input against 12 kg output. In case of discrepancy in the accuracy of the scales a different set of scales was used.

This static test confirms the principle of the apparatus in that it takes one unit of force to advance the weights against that same unit of centrifugal force, and the twofold apparatus application of this force delivers it to the output at twice the input. The second force being the harnessing of centrifugal force which is the by-product of the angular momentum resulting from the transmission of first force.

A further test measuring the relative force of the input and that required to balance the centrifugal force simulation using the above equipment, confirmed that the input force is the same as the centrifugal force simulation. It also follows from this that any change that may be made to the weights or the length of their arms, this 1:1 ratio will hold.

Since input force was confirmed above to be expressed as twice the input at the output, it follows that the output at any given revs can be calculated from a calculation of the centrifugal force.

With standard gearing; using a 3 hp motor with variable speed and directional features to power the input shaft while the apparatus 2 was driven in the standard manner from the input shaft via the input chain. A comparison was made when:
1. A V belt drive was configured with an adjustable tension pulley so as to convey drive to a positive drive water gear pump from a four inch pulley on the output of the apparatus;
2. A V belt drive was configured with an adjustable tension pulley so as to convey drive to the positive drive water gear pump from a four inch pulley on the input shaft.
   This meant that in both 1 & 2 the motor had to drive the apparatus requiring the motor to meet the resistance exerted by driving the apparatus.

### Additionally in;

1. The resistance to drive the water pump, less the gain in power created by the apparatus;
2. The resistance to drive the water pump, without any assistance in power created by the apparatus.

The test result was;
a) After activating the motor to run at an estimated 200 rpm the water pump was engaged and it pumped water through an open tap and garden half inch hose at 90 psi without any reduction for the duration of the test.
b) After activating the motor to run at an estimated 200 rpm the water pump was engaged the result was an immediate pressure registration at the pump followed by an equally quick drop in pressure as the motor stalled.

Conclusion from this test is that, the apparatus produced power. This can be expressed as there being more power coming from the output than was applied at the input.

A test using apparatus 2 conducted where a 20 KVA generator was driven from the output showed that input power put in beyond the start-up power requirement was amplified to one and a half times that power as the following explains.

With no load connected, only generator Input power was 1750 Watts when running at 380 rpm. Output load was added of 600 watts. If the apparatus conveyed input to output at 100% efficiency it would be expected that the addition of 600 Watts at the output would have required 600 additional input Watts on top of the 1750 Watts making a total input Watts needed of 2350 Watts.

During this test the input was going up but failed. It is consistently stated that the motor cuts out at 2200 Watts. Therefore 2350 could not have been supplied. Therefore the 600 additional output Watts must have been supplied at less than 600 Watts of input. In fact there could only have been 2200 less 1750 making 450 Watts of capacity before cut-off. Therefore a maximum of 450 input watts produced 600 Watts of output. This is a conversion of 3 to 4 and is within the claims of apparatus of 1 to 2 less friction (in this case, increase in friction as input and output increased, NB With the low revs of the generator very low efficiency would be expected).

Below are the results of tests on the apparatus 2. The apparatus 2 was set with the weights at about 15° advance and the motor running at 15 hertz. The rev counter was showing the radial arms to be revolving at 330 rpm and the output gear to be revolving at 450 rpm when this spontaneously increased to 800 rpm in a less than two seconds. The noise of apparatus 2 indicated a violent and sudden increase of rpm as well as a change in the sound of the input motor which appeared to lose any sound of effort.

The self-powering all happened within a matter of two seconds, and can only be explained as the result of the apparatus 2 supplying its own power and overpowering the motor. This response by the apparatus is consistent with the design principles and formula. The increase in output revs to 800 rpm can only be from power amplified by the apparatus since the motor's inbuilt cut out is set at 2,200 watts which other tests have shown can only power the apparatus to 582 rpm. It could not be a release of any built in kinetic or flywheel energy as the gearing of apparatus is such that any change in rpm of any internal parts can only result in a proportional reduction elsewhere so that there is no change in the ratio of input to output rpm, in other words input and output revs must always be the same as each other.

Many photographs and videos have been taken of the apparatus running with the return chain in place and with or without the motor running, all have consistently shown the output loading tension which is drive being applied from the output to the input.

Other trials included the confirmation of the direction of centrifugal force as being directly out from the centre of rotation. This was necessary to prove since physicists dispute centrifugal force. The apparatus was run at 5 hertz using two settings of the return chain in place to set the weights at approximately positive 10° and negative 10°. It was observed that the positive advance produced a positive drive of the frame gear while the negative setting produced a negative drive of the frame gear which confirmed the outward pull of centrifugal force.

It was shown that increasing the advance of the weights did increase the output revs, and that this could be controlled by the weight advancing devices. A weight advancing device was tested by altering the relative length of chain on the tension and non-drive sides between the output and input sprockets. When the length ratio was changed the resultant change to the sprockets did alter the amount of advance. With the motor set a 5 hertz the revs were compared when the device was moved to alter the advance of the weights backwards and forth by some 15° the revs altered between 130 and 114 rpm.

This result confirmed three things that even at revs as low as around 100 rpm at which centrifugal force would only have applied a multiple of approximately 8 times mass (gravity):
1. The second force was applying power;
2. That the second force did function at small advance setting as well as increase power at greater advance settings; and
3. And this could be adjusted by changing the advance setting of the weights.

It does not follow that at higher revs, such as 350 rpm (when the hertz are set at 15) that apparent elongation of the tension side of the output returning chain will produce the same relative increase in the second force. This is because as radial arm revs increase, an exponential increase occurs in the centrifugal force. This requires greater input force to advance the weights. With this applied through the chains, stretch occurs in the chains which allows the weights to pull in from the advance setting that the return chains were set to when not stretched. This reduces transfer of weight offsetting of the frame gears and so reduces the second force.

This reduction in advance does not diminish the demands of input force because unused potential energy in stretching the chain is still required even though the weights are no longer held to the advance setting. With the weights not as advanced, or even not advanced at all, there is much less, or even no second force response to the input. This leaves only the first force fully working to match input, and the reduced second force to provide the increase power to drive friction and surplus usable “universal energy” (from centrifugal force).

The stretch of the chain is analogous to a weak spring in a bathroom scale that allows the dial to turn to a much higher reading than the person weight. A direct coupling of the output shaft to the multiple chain sprockets using the “Helical Slotted Piston Coupling” was applied also.

| | Radial Arm | | Output (rpm with | |
|---|---|---|---|---|
| Hertz | (rpm) | Output (rpm) | weights advanced) | Increase in rpm |
| | 114 | 114 | 130 | 16 |
| 3 | 209 | 209 | 266 | 57 |
| 4 | 232 | 232 | 317 | 85 |
| 6 | 330 | 330 | 450 | 120 |

The rpm increase conforms to the formula for centrifugal force where increase in power is proportional to the square of the increase in revs.

Physical comparisons have been made between input power and output power. Duplicating hand resistance applied to the input and output shafts of apparatus 1 have been graphed showing a near incapacity to slow let alone stop the output while the input was easily sloped. (See FIGS. 5 to 15)

Similarly apparatus 2 tested in Melbourne, Victoria was tested while running at 5 hertz, firstly by hands on identical pullies. Again this resulted in a near incapacity to slow let alone stop the output while the input was easily stopped.

### Advantages

Given the properties of mass exhibited by a body spinning around a fixed point expresses angular momentum and centrifugal force, the function of the unit is to spin a body so as to maintain the angular momentum and convert centrifugal force into a cranking force to generate energy.

The apparatus of the present invention has a number of applications including as stand-alone power plants as single units or multiple units in any configuration including stacked on top of one another, side by side including on common axle shafts, for any mechanical energy application including water pumping and treatment, the generation of electricity, powering of vehicles, marine vessels, air craft, or any other mechanical device including use in space or anywhere. The machine of the invention may be made to any size to suit any requirement for on-site and portable, to regional supply of energy. Regional power generation would eliminate the need and costs associated with long distance transportation of energy be it electricity or fossil fuel.

The powering system incorporated in the current invention has been tested and provides a simple, compact energy generating system and is lighter in its construction and so is cost effective when compared to internal combustion motors or other mechanical systems. It can operate anywhere and is not dependent on environmental conditions particularly in that it requires no fuel and emits no emissions or waste by-products such as noise and heat. It can be made to sizes from very small to very large to suit any application that an internal combustion motor could be used.

### Variations

All references to the term “centrifugal force” are meant as a descriptive term for an equal and opposite outward pull to centripetal force and are not dependent on any particular definition.

The current invention is intended as a description of the principles of power generation and application. The interconnection of the components may be varied for any reason including convenience or efficiency. The components herein may be altered for any suitable function to apply the principles as implied herein. The number of any components may be varied for greater convenience or efficiency but this does not alter the method of operation.

The drawings herein do not display definitive specifications as they are for explanatory and demonstration purposes only. The non-inclusion of idler gears or locating them at a different point may change the mechanics of the operation but not the principle of converting centrifugal force into a usable energy resource.

Dimensions, rpm, direction of rotation, gearing and weight of components may be varied for the efficiency and output of any unit.

The above is limited by structural strength. This again can be enhanced by the use of superior materials.

All moving parts should be enclosed by protective casing to prevent injury or damage that would be caused by any intrusion into the machinery or the escape of any parts which could be at high velocity under circumstances of mechanical failure however caused.

All bearings and abrading or frictional surfaces must be kept appropriately lubricated, with any spillage or recycling able to be effected by a dual function of the protective casing. Although it is unnecessary due to the relative insignificance of friction, even this could be reduced by the application of the protective casing being a vacuum sealing casing and so eliminate wind friction if thought desirable.

It is important that the apparatus should have at least a speed reducing system such as the power regulator; additionally a breaking system can be installed on the output to prevent uncontrolled power in an emergency.

The terms “comprising” or “comprises” as used throughout the specification and claims are taken to specify the presence of the stated features, integers and components referred to but not preclude the presence or addition of one or more other feature/s, integer/s, component/s or group thereof.

Whilst the above has been given by way of illustrative embodiment of the invention, all such variations and modifications thereto as would be apparent to persons skilled in the art are deemed to fall within the broad scope and ambit of the invention as defined in the appended claims.

### PARTS LIST

Part identification list applies to;—ON FIGS. 1,2 & 3.
11. Housing frame.
14. Input shaft.
15. Bearings.
16&17 Radial arms.
19. Bearings
20. Output gear.
21. Pedestal shafts.
22. Idler Gear.
24. Frame gear.
25. Bearings.
26. Frame gear shaft.
27. Bearings.
28. Bearings.
29. Drive gear.
30. Pedestal shafts.
31. Weight gear.
32. Bearings.
33. Weights.
34. Final chain sprocket.
35,36,38 Multiple drive sprocket (MDS)
37. Drive chain.
38. Input drive sprocket.
39. Starter motor.
40. Starter motor input,
ON FIG. 16
12. Multiple drive sprocket (MDS)
15. Helical slotted pistons. (HSPC)
16. Helical slots.
17. Oil line.
18. Oil line outlet.
19. Internal slots.
20. Drive pin threads.
21. Drive pins.

1. An energy generation apparatus comprising:
a dual function input shaft and output shaft rotatably attached to opposite sides of a housing defining an axis of orbit;
an output gear fixed for rotation with said output shaft;
an input sprocket rotatably mounted on said output shaft;
at least two frame gear assemblies, each said frame gear assembly comprising a frame gear, a shaft, a drive gear, weight gears and an idler gear, wherein said at least two frame gear assemblies having an axis of rotation, said frame gear assemblies being mounted for orbital movement around said output gear in response to an input from said input sprocket, and means to convey said orbital movement to the output gear;
means for positioning and maintaining the effective center of mass of said frame gear at a position or positions synchronously off-center relative to the center of said frame gears to cause rotation of said frame gear about their axis of rotation in response to a centrifugal force caused as a consequence of the orbital movement of said frame gear assemblies;
means of coupling said frame gears to said output gear via said idler gear and reversing the direction whereby motion of said frame gear is transmitted to said output shaft equal to said input of the frame gear assemblies around said output gear; and
wherein said spin of the output gear is conveyed via the output shaft to return some of output energy to drive the input by direct or variable mechanical drive, or by any other means such as hydraulic or electric drive systems, so as to maintain the system.

2. Apparatus as claimed in claim 1 and including at least one pair of frame gear assemblies, respective frame gear assemblies of said pair being arranged symmetrically on opposite radial sides of the output gear.

3. Apparatus as claimed in claim 2 wherein each said frame gear assembly comprises a frame gear and mass adjusting means carried by said frame gear for adjusting the center of mass of the frame gear assembly.

4. Apparatus as claimed in claim 3 and including a frame gear shaft for each frame gear assembly and mounted at a position spaced radially from and extending parallel to the output shaft, said frame gear assembly being supported to the frame gear shaft for free rotation there around.

5. Apparatus as claimed in claim 4 wherein said mass adjusting means comprise weight gears, said weight gears being movably mounted on the frame gear to enable adjustment of the effective center of mass of the frame gear assembly.

6. Apparatus as claimed in claim 5 wherein said weight gears comprise a pair or more of weight gears arranged symmetrically on opposite radial sides of the axis of rotation of the frame gear.

7. Apparatus as claimed in claim 6 wherein each weight: gear is supported on the frame gear for rotation about art axis extending parallel to the axis of the rotation of the frame gear.

8. Apparatus as claimed in claim 7 wherein the center of mass of each weight gear is offset relative to its axis of rotation and maintains that offset synchronously such that offset is maintained even when the frame gear rotates about its own axis.

9. Apparatus as claimed in claim 8 wherein said weight gears are arranged such that when each weight or center of mass of each weight gear is concurrently radially outer most and wherein the weight gears on frame gears on the opposite sides of the output shaft are arranged symmetrically relative to each other.

10. Apparatus as claimed in claim 9 wherein said weight gears are in mesh with a common drive gear coaxial with the frame gear through which rotation by a drive chain can be transmitted to the weight gears from the input sprocket, said drive gear being mounted to frame gear shaft for rotation therewith.

11. Apparatus as claimed in claim 10 wherein said frame gear shafts are supported by spaced radial arms mounted for rotation relative to the output shaft, the radial arms extending symmetrically on opposite radial sides of the output shaft.

12. Apparatus as claimed in 11 wherein each said frame gear assemblies is coupled to the output gear through idler gears.

13. Apparatus as claimed in claim 12 wherein said frame gear shafts are adapted to receive an input from said input sprocket to rotatably drive the drive gears against the weight gears with said weights which are synchronously held outwards by centrifugal force.

14. Apparatus as claimed in claim 13 wherein said orbital motion is applied to said frame gear assemblies as torque.

15. Apparatus as claimed in claim 14 wherein the torque will be resisted as spin by the coupling to the output gear causing the drive chains to act as a solid.

16. Apparatus as claimed in claim 15 wherein the solid behaviour of the chains will be applied to the frame gear assembly as rotational torque about the output shaft for complete conveyance of all input less friction through the meshing of the drive gear to the weight gears to the frame gears to the idler gears to the output gear to form a first force applied to the output gear.

17. Apparatus as claimed in claim 16 wherein when the frame gear assembly is rotating about the output shaft all parts of the frame gear will express centrifugal force as a by-product which increases as the radial arms rotate faster.

18. Apparatus as claimed in claim 17 wherein any increase in revolution rate of the radial arms increases both rotational force and centrifugal force applied to the weights by a factor of four proportionally in accordance with E=½MV² and F=MV²/R and will increase the power range that can be amplified.

19. Apparatus as claimed in claim 16 wherein said rotation transmitted to the weight gears will cause the weights thereon mounted to move away from the most outward line causing said mass adjusting in response to any differential between the input and output power caused by friction or output load.

20. Apparatus as claimed in claim 19 wherein average movement of the weights being so caused, and being subjected to said centrifugal force, will apply the same torque as that force that caused it in the conveyance of the first force.

21. Apparatus as claimed in claim 20 wherein the torque is applied to the frame gear in response to the centrifugal force applying to it in a radial line from the output shaft.

22. Apparatus as claimed in claim 21 wherein said torque (less friction) is applied through the idler gears in a reverse direction to the output gear to form a second force applied to the output gear.

23. Apparatus as claimed in claim 22 with both the first force and the second force governed by the input meeting resistance against rotation of the weight gears which are held by centrifugal force being a by-product of angular momentum, both the first and second forces apply equal output force regardless of their revolution rates.

24. Apparatus as claimed in claim 23 wherein all gearing is configured to suit the method of maintaining the input power when diverting any of the output to the input.

25. Apparatus as claimed in claim 24 wherein the gearing is a one to one gearing if all power is to be returned at a one to one revolution rate which requires the rotation of either the frame gears or the radial arms singularly, or any combined rotation of the frame gears or the radial arms to match the input rotation rate that these gears cause at the output, and with both applying the same torque the output will equal twice the input power less friction.

26. Apparatus as claimed in claim 25 wherein the first force is applied with any sprocket sizing when it alone is rotating requiring only the gearing of the second force to be configured one to one such that a combined one to one gearing is maintained when the frame gears rotate about their own axis.

27. Apparatus as claimed in claim 26 wherein calculating the one to one gearing of the second force it must be factored in that throughout each rotation of the radial arms, the weight gears maintain their orientation, and in doing so revolve around the drive gear, such that the drive gears must turn the number of teeth as there are on the weight gears in addition to the one full turn of the drive gear required to match the rotation of one frame gear rotation.

28. Apparatus as claimed in claim 27 wherein the first force is a direct product of the input force and is fully conveyed to the output, and the second force is a consequential force resultant from centrifugal force acting on the advance of the weights, all the output of the second force less frictional loss, is gain, and so can be used to power an external application.

29. Apparatus as claimed in claim 28 wherein power is increased by incorporating multiple frame gears, weight gears or the use of modified weight arms whereby the weight gears can be mounted on shafts extending through the frame gears and mounted on bearings such that the non-gear drive side has a weight arm attached, such that with the weights balanced on either side, a more even load would be applied to the frame gears while increasing the mass of the weights and so the power range that can be amplified.

30. Apparatus as claimed in claim 29 wherein multiple force or energy amplifying apparatuses may be powered in series for multiple amplification of power for returning power for self-powering.

31. An apparatus for harnessing centrifugal force into a cranking force to apply energy to a shaft when the centre of gravity/mass within a gear is manipulated to rotate continuously off centre to one side of that gear around the centre of another gear, the apparatus comprising:
a dual function input shaft and output shaft rotatably attached to opposite sides of a housing defining an axis of orbit;
an output gear fixed for rotation with said output shaft;
an input sprocket rotatably mounted on said output shaft;
at least two frame gear assemblies, each said frame gear assembly comprising a frame gear and an idler gear, wherein said at least two frame gear assemblies having an axis of rotation, said frame gear assemblies being mounted for orbital movement around said output gear in response to an input from said input sprocket, and means to convey said orbital movement to the output gear;
means for positioning and maintaining the effective center of mass of said frame gear assemblies at a position or positions synchronously off-center relative to the center of said frame gears to cause rotation of said frame gear assemblies about their axis of rotation in response to a centrifugal force caused as a consequence of the orbital movement of said frame gear assemblies; and
means of coupling said frame gears to said output gear via said idler gear whereby motion of said frame gear is transmitted to said output shaft equal to said input of the frame gear assemblies around said output gear.

33. Apparatus as claimed in claim 32, wherein energy at the output shaft is transmitted to the input sprocket to recycle energy so as to provide power for self-powering the apparatus and providing a continuous supply of power for external applications.

34. Apparatus as claimed in claim 33, wherein the self-powering apparatus is a variable power hydraulically controlled returning apparatus or a power regulator for maintaining, increasing, reducing or stopping the power transmitted from the output to the input, said power regulator being incorporated within a multiple chain sprocket.

35. Apparatus as claimed in claim 34, wherein a hydraulic cylinder is created on an inner side of said multiple chain sprocket to form the housing of the variable power returning apparatus.

36. Apparatus as claimed in claim 35, further comprising two pistons located on the inner side of the multiple chain sprocket.

37. Apparatus as claimed in claim 36, wherein each piston has at least two slots equally spaced around the insides and outsides of both pistons.

38. Apparatus as claimed in claim 37, wherein the inside slots are horizontal.

39. Apparatus as claimed in claim 37, wherein the outside slots are helical.

40. Apparatus as claimed in claim 34, wherein threaded holes are located around the multiple chain sprocket to align with the said helical slots and the insertion of screw pins.

41. Apparatus as claimed in claim 40, wherein each set of screw pins is positioned so as to locate into the helical slots in the outside of each of said two pistons.

42. Apparatus as claimed in claim 41, wherein said pistons are tubular such that they are located to neatly fit around the output shaft.

43. Apparatus as claimed in claim 42, wherein hydraulic seals are located on the inner lacing ends of each said piston and set back to allow a space between the two pistons when they are together, so as to facilitate controlled separation by maintaining a space for hydraulic oil

44. Apparatus as claimed in claim 43, wherein each set of pistons is engaged by a set of locating pins which are inserted equally around, or on opposite sides of the output shaft such that half of the locating pins are spaced to engage with each piston.

45. Apparatus as claimed in claim 44, wherein said engaging pins are fitted into said longitudinal slots on the inside of said pistons, by sliding said pistons outward after the said pins are inserted into the said output shaft.

46. Apparatus as claimed in claim 45, wherein said pistons are then free to slide horizontally on the output shaft as far as the seals will permit.

47. Apparatus as claimed in claim 46, wherein said output shaft has an axially extending hole drilled through the middle of the output shaft and extending from one side of multiple chain sprocket to an outlet hole located in line with the mid line of the final drive sprockets.

48. Apparatus as claimed in claim 35, where said cylinder of the multiple chain sprocket is slid over the pistons to accommodate the pistons centrally, when the pistons are together at the point of the oil outlet hole so as to align with the mid line of the final drive sprocket.

49. Apparatus as claimed in claim 39, wherein the helical slots in the outside of the two pistons are cut at opposite angles to each other and are fitted on the output shaft such that the slots form an arrow head in the direction of rotation of the output shaft.

50. Apparatus as claimed in claim 49, wherein the slots are cut at any suitable helical angle so as to provide optimal rotation of the weights to near ninety degrees when the pistons are hydraulically separated by an hydraulic pump to their maximum extent.

51. Apparatus as claimed in claim 50, where the multiple chain sprocket is coupled to the final drive sprocket of the apparatus by the drive chains in such a manner that when the pistons are together at the outlet oil hole, each of the weights on the weight gears are set outwards on the radial line or slightly backwards from it.

52. Apparatus as claimed in claim 47, wherein on the drilled end of said output shaft is fitted a rotary oil union with an hydraulic pump connected via a hydraulic hose to the rotary oil union.

53. Apparatus as claimed in claim 52, wherein the hydraulic fluid pressure is provided between the pistons to cause the pistons to move apart such that movement of the pistons apart will screw the cooperating pins along the slots causing a differential rotational coupling between the input sprocket and the output shaft.

54. Apparatus as claimed in claim 53, wherein said rotational differential coupling will transfer downstream to force and hold the weights off-centre.

55. Apparatus as claimed in claim 54, wherein said weight offset will cause torque and rotation of the frame gear assembly to be applied to the output.

56. Apparatus as claimed in claim 55, wherein the output can be additionally returned to the input or made available to power or drive other applications.
